(19) United States
(12) Patent Application Publication
(10) Pub. No.: US 2026/0244070 A1
(43) Pub. Date: Aug. 20, 2026

(54) OPTICAL WAVEGUIDE ELEMENT, OPTICAL MODULATOR, AND OPTICAL TRANSMITTER

(71) Applicant: SUMITOMO OSAKA CEMENT CO., LTD., Tokyo (JP)

(72) Inventors: Masayuki MOTOYA, Tokyo (JP); Yu KATAOKA, Tokyo (JP); Shingo TAKANO, Tokyo (JP)

(21) Appl. No.: 19/445,811

(22) Filed: Jan. 12, 2026

(30) Foreign Application Priority Data
Feb. 17, 2025 (JP) 2025-023438

(51) Int. Cl. G02F 1/21; G02F 1/01; G02F 1/225

(52) U.S. Cl. CPC G02F 1/212; G02F 1/0123; G02F 1/0147; G02F 1/225

(57) ABSTRACT

Provided is an optical element to appropriately adjust the bias point using the thermo-optical effect while suppressing thermal crosstalk between optical waveguides, and achieve compactness and high density. An optical waveguide element comprises a rectangular substrate made of electro-optical crystal and having first and second directions in a planar view, an optical waveguide formed on the substrate, and a bias control section having a heater electrode that heats the optical waveguide. The optical waveguide includes a Mach-Zehnder optical waveguide having multiple branch waveguides branched by at least one branching section. Each of the branch waveguides has a curved waveguide and the curved waveguides of each branch waveguide are arranged to be spaced apart along the first direction at a predetermined distance or more. A heater electrode is disposed on at least one of the curved waveguides.

### TECHNICAL FIELD

The present invention relates to an optical waveguide element having an optical waveguide formed therein, an optical modulator including the optical waveguide element, and an optical transmitter including the optical modulator.

### BACKGROUND ART

In the fields of optical measurement technology and optical communication technology, optical waveguide elements each comprising a substrate on which an optical waveguide is formed are used. The optical waveguide element of an optical modulator uses a substrate made of a material with an electro-optical effect, such as lithium niobate (LiNbO₃: hereafter referred to as LN). In recent years, advances in substrate processing technology have made it possible to produce thin substrates, as well as to spur research and development aimed at miniaturizing and increasing the density of optical waveguide elements.

In optical modulators using materials with an electro-optical effect, the bias point can be adjusted by applying a voltage to change the refractive index within the optical waveguide. However, adjusting the bias point by applying a voltage is likely to occur DC drift due to factors such as charge accumulation, thereby resulting in causing the bias point to move. In order to suppress such DC drift, it is required to adjust multiple process parameters, thereby making it difficult to control the bias point.

On the other hand, a method for adjusting the bias point using the thermo-optical effect has also been proposed. In this method, a heater electrode is arranged to raise the temperature of the optical waveguide. The temperature of the optical waveguide is increased by passing electric current through the heater electrode to heat the optical waveguide. By appropriately controlling the temperature of the optical waveguide and changing the refractive index of the optical waveguide, the phase of the light wave propagating through the optical waveguide can be changed.

Japanese Patent Application Publication No. 2023-156778 discloses a Mach-Zehnder type optical modulator that uses the structure of a Mach-Zehnder interferometer. The optical modulator disclosed in Japanese Patent Application Publication No. 2023-156778 includes a DC phase shifter composed of a heater electrode. By applying power to the heater electrode to heat each branched optical waveguide, the optical refractive index of each optical waveguide is appropriately changed by the thermo-optical effect, thereby shifting the phase of the signal light. The amount of phase shift in each optical waveguide is adjusted by setting the width of the heater electrode and the length of its action on the optical waveguide. Japanese Patent Application Publication No. 2023-156778 also discloses setting the length of the waveguide to be heated by changing the number of times the optical waveguide is folded.

### SUMMARY

### Problem to be solved by the invention

Japanese Patent Application Publication No. 2023-156778 discloses that by heating the two respective branched optical waveguides in different ways, the amounts of phase shift in the two respective branched optical waveguides can be adjusted. However, Japanese Patent Application Publication No. 2023-156778 does not take into consideration the occurrence of thermal crosstalk between the two branched optical waveguides. Specifically, there is a problem in that heat from a heater electrode that heats a specific optical waveguide is transferred to another optical waveguide formed around it. For example, heat intended to heat one of two branched optical waveguides is transferred to the other optical waveguide, thereby resulting in a small temperature difference between the two optical waveguides and thus making it difficult to perform suitable phase control in an accurate manner.

The present invention has been made in consideration of the above problem, and aims to provide an optical waveguide element that can appropriately adjust the bias point using the thermo-optical effect while suppressing thermal crosstalk between optical waveguides, and that can achieve miniaturization and high density, as well as an optical modulator including such an optical waveguide element and an optical transmitter including such an optical modulator.

### Means for solving the problems

In order to solve the above problem, the optical waveguide element, optical modulator, and optical transmitter of the present invention have the following technical features.

The optical waveguide element according to the present invention comprises a rectangular substrate made of electro-optical crystal and having a first direction and a second direction in a planar view, an optical waveguide formed on the substrate, and a bias control section having a heater electrode for heating the optical waveguide. The optical waveguide includes a Mach-Zehnder optical waveguide having a plurality of branch waveguides branched by at least one branching section, the plurality of branch waveguides having curved waveguides, respectively, and the curved waveguides of each branch waveguide are arranged to be spaced apart along the first direction at a predetermined distance or more, and the heater electrode is disposed on at least one of the curved waveguides.

With the above configuration, the heater electrode disposed on the curved waveguide enables phase control of light by utilizing the thermo-optical effect. Furthermore, because the curved waveguides constituting each branch waveguide are arranged to be spaced apart at least a predetermined distance apart in the first direction, thermal crosstalk between the branch waveguides is suppressed, preventing degradation of control accuracy due to thermal crosstalk. Furthermore, by arranging the curved waveguides on which heater electrodes are arranged in the first direction, an increase in dimension in the second direction is suppressed, thereby achieving a smaller, high density optical waveguide element.

In the above configuration of the optical waveguide element according to the present invention, the curved waveguides of each branch waveguide may have the same shape.

With the above configuration, by making the curved waveguides of each branch waveguide to be formed in the same shape, variation in the optical path length of each branch waveguide can be suppressed, ensuring uniform optical characteristics.

In the above configuration of the optical waveguide element according to the present invention, the curved waveguide may be configured to include N (N is a positive even number) curved folded portions and N+1 straight portions extending in the first direction which are alternately connected to each other.

With the above configuration, a predetermined area can be secured within the substrate surface by the curved waveguide in which the folded portions and the straight portions are alternately connected to each other. This allows a heater electrode for heating a specific branch waveguide to be positioned so that other branch waveguides are not included in its heat conduction range, thereby making it possible to suppress thermal crosstalk to other branch waveguides.

In the above configuration of the optical waveguide element according to the present invention, the heater electrode may be disposed in the vicinity of the straight portion.

With the above configuration, the heating of the straight portions makes the thermo-optical effect of the heater electrode to be applied evenly and efficiently, thereby enabling to achieve highly accurate phase control.

In the above configuration of the optical waveguide element according to the present invention, the substrate may be covered with a buffer layer, and the heater electrode may be disposed to heat the curved waveguide through the buffer layer.

With the above configuration, the buffer layer can prevent the heater electrode from coming into direct contact with the substrate, thereby improving electrical and thermal stability and preventing the heater electrode from absorbing light propagating through the optical waveguide.

In the above configuration of the optical waveguide element according to the present invention, the curved waveguide may have a second direction extending portion that increases the separation distance in the second direction from another branch waveguide.

With the above configuration, the curved waveguide has a second direction extending portion, thereby ensuring an appropriate separation distance in the second direction between the branch waveguides. Furthermore, since the second direction extending portions of each branch waveguide are arranged to be spaced apart along the first direction at a predetermined distance or more, the separation distance between the branch waveguides in the first direction can be appropriately ensured. This makes it possible to suppress thermal crosstalk to other branch waveguides by the heater electrode disposed on a specific curved waveguide.

The optical waveguide element according to the present invention may further include a groove formed by removing a portion of the substrate between the heater electrode for heating a specific optical waveguide and the other optical waveguides.

With this configuration, the groove can reduce the amount of heat generated by the heater electrode that is conducted to the other optical waveguides, thereby suppressing thermal crosstalk.

The optical waveguide element according to the present invention may further include a heat dissipation material made of metal disposed over part or all of the groove.

With this configuration, thermal energy accumulated during and after heating can be efficiently released to the outside.

In the above configuration of the optical waveguide element according to the present invention, multiple Mach-Zehnder optical waveguides may be formed on the substrate.

This configuration makes it possible to suppress thermal crosstalk in the multiple branch waveguides included in the multiple Mach-Zehnder optical waveguides, and enables the optical waveguide element to be made small in size and high density.

In the above configuration of the optical waveguide element according to the present invention, multiple Mach-Zehnder optical waveguides may be arranged nested or in parallel.

With the above configuration, it is possible to suppress thermal crosstalk and achieve a smaller, high density optical waveguide element for an optical waveguide element including multiple Mach-Zehnder optical waveguides arranged nested or in parallel.

In order to achieve the above object, the optical modulator according to the present invention comprises the above optical waveguide element, a housing for accommodating the optical waveguide element, an input optical fiber connected to the optical input section of the optical waveguide element, and an output optical fiber connected to the optical output section of the optical waveguide element.

In order to achieve the above object, the optical transmitter of the present invention comprises the above optical modulator, a light source for inputting light waves to the optical modulator, and a signal output circuit for outputting the modulated signal.

### Effects of the invention

The present invention can provide an optical waveguide element that utilizes the thermo-optical effect to appropriately adjust the bias point while suppressing thermal crosstalk between optical waveguides, as well as achieving compactness and high density. The present invention can also provide an optical modulator including the optical waveguide element, and an optical transmitter including the optical modulator.

### BRIEF DESCRIPTION OF DRAWINGS

FIG. 1A is a diagram illustrating the basic concept of the present invention, showing a branch waveguide formed in a linear state.

FIG. 1B is a diagram illustrating the basic concept of the present invention, showing a branch waveguide including a curved waveguide.

FIG. 1C is a diagram illustrating the basic concept of the present invention, showing a portion of a Mach-Zehnder optical waveguide embodying the basic concept of the present invention.

FIG. 2A is a diagram illustrating an example of a curved waveguide that constitutes a part of a Mach-Zehnder optical waveguide that reflects the basic concept of the present invention, showing a case where the curved waveguide is a folded type waveguide formed in an S-shape.

FIG. 2B is a diagram illustrating an example of a curved waveguide that constitutes a part of a Mach-Zehnder optical waveguide that reflects the basic concept of the present invention, showing a case where the curved waveguide is a folded type waveguide formed in an inverted S-shape.

FIG. 2C is a diagram illustrating an example of a curved waveguide that constitutes a part of a Mach-Zehnder optical waveguide that reflects the basic concept of the present invention, showing a case where the curved waveguide is a serpentine waveguide.

FIG. 3 is a diagram showing an example of a part of a nested Mach-Zehnder optical waveguide that reflects the basic concept of the present invention.

FIG. 4 is a plan view of an optical waveguide element in a first embodiment of the present invention.

FIG. 5 is a cross-sectional view taken along line A-A in FIG. 4.

FIG. 6 is a cross-sectional view showing a first example of arrangement of heater electrodes in the vicinity of a branch waveguide in the first embodiment of the present invention.

FIG. 7 is a cross-sectional view showing a second example of arrangement of heater electrodes in the vicinity of a branch waveguide in the first embodiment of the present invention.

FIG. 8 is a cross-sectional view showing a third example of arrangement of heater electrodes relative to the vicinity of a branch waveguide in the first embodiment of the present invention.

FIG. 9 is a cross-sectional view showing a fourth example of arrangement of heater electrodes relative to the vicinity of a branch waveguide in the first embodiment of the present invention.

FIG. 10 is a cross-sectional view showing a fifth example of arrangement of heater electrodes relative to the vicinity of a branch waveguide in the first embodiment of the present invention.

FIG. 11 is a partial plan view of the vicinity of a curved waveguide showing a first example of arrangement of heater electrodes relative to the curved waveguide in the first embodiment of the present invention.

FIG. 12 is a partial plan view of the vicinity of a curved waveguide showing a second example of arrangement of heater electrodes relative to the curved waveguide in the first embodiment of the present invention.

FIG. 13 is a partial plan view of the vicinity of a curved waveguide showing a third example of arrangement of heater electrodes relative to the curved waveguide in the first embodiment of the present invention.

FIG. 14 is a plan view of an optical waveguide element in a second embodiment of the present invention.

FIG. 15 is a cross-sectional view taken along line B-B in FIG. 14.

FIG. 16 is a cross-sectional view taken along line C-C in FIG. 14.

FIG. 17 is a plan view of an optical waveguide element in a derivative example of the second embodiment of the present invention.

FIG. 18 is a cross-sectional view taken along line D-D in FIG. 17.

FIG. 19 is a cross-sectional view taken along line E-E in FIG. 17.

FIG. 20 is a plan view of an optical waveguide element in a third embodiment of the present invention.

FIG. 21 is a partial plan view of the vicinity of a curved waveguide, showing a first example of arrangement of heater electrodes relative to the curved waveguide, in the third embodiment of the present invention.

FIG. 22 is a partial plan view of the vicinity of a curved waveguide, showing a second example of arrangement of heater electrodes relative to the curved waveguide, in the third embodiment of the present invention.

FIG. 23 is a partial plan view of the vicinity of a curved waveguide, showing a third example of arrangement of heater electrodes relative to the curved waveguide, in the third embodiment of the present invention.

FIG. 24 is a plan view of an optical waveguide element in a fourth embodiment of the present invention.

FIG. 25 is a partial plan view showing a first alternative example of a portion of a Mach-Zehnder optical waveguide according to the fourth embodiment of the present invention.

FIG. 26 is a partial plan view showing a second alternative example of a Mach-Zehnder optical waveguide according to the fourth embodiment of the present invention.

FIG. 27 is a partial plan view showing a third alternative example of a Mach-Zehnder optical waveguide according to the fourth embodiment of the present invention.

FIG. 28 is a plan view showing an optical modulator and an optical transmitter according to the present invention.

FIG. 29 is a first diagram for explaining the problem of the present invention.

FIG. 30 is a second diagram for explaining the problem of the present invention.

FIG. 31 is a third diagram for explaining the problem of the present invention.

### DETAILED DESCRIPTIONS

Embodiments of the present invention will now be described with reference to the drawings. The drawings referred to in this specification are not necessarily drawn to exact scale relative to the actual dimensions, and some parts have been exaggerated or simplified to schematically illustrate the configuration according to the present invention. Numerical ranges described herein include upper and lower limits, meaning that any value within the range can be selected. The drawings are illustrated using an XYZ coordinate system. The optical waveguide element according to the present invention has a rectangular flat plate structure when viewed from above. The first direction when viewed from above is the X direction, the second direction is the Y direction, and the normal direction to the top surface is the Z direction. Note that in the embodiment described herein, X-cut lithium niobate (LN) is used as the material exhibiting the electro-optical effect. In this case, the first direction, the X direction, corresponds to the Y axis in terms of the crystallographic axis, and the second direction, the Y direction, corresponds to the Z axis in terms of the crystallographic axis.

### Basic concept of the present invention

First, the basic concept of the present invention will now be explained.

The optical waveguide element according to the present invention is configured with a Mach-Zehnder optical waveguide having multiple branch waveguides branched by at least one branching section. The optical waveguide element according to the present invention may also be provided with multiple Mach-Zehnder optical waveguides. Multiple Mach-Zehnder optical waveguides may be arranged in a nested structure.

The optical waveguide element according to the present invention has a heater electrode disposed in the vicinity of at least one branch waveguide. The heater electrode shifts the phase of light propagating through the branch waveguide using the thermo-optical effect. By heating the branch waveguide with the heater electrode and controlling the refractive index of the branch waveguide, the bias point is adjusted using the thermo-optical effect.

FIGS. 29 to 31 are first to third diagrams for explaining the problems of the present invention.

FIG. 29 schematically shows a portion of a Mach-Zehnder optical waveguide 2100 according to the prior art. In the Mach-Zehnder optical waveguide 2100 shown in FIG. 29, a single input optical waveguide 2101 branches into two branch waveguides 2103 and 2104 at the branching section 2102. The two branch waveguides 2103 and 2104 extend parallel to each other in the X direction. The light propagates in the positive X direction (from left to right in the figure). The combining section located at the end of the Mach-Zehnder optical waveguide is not shown.

A heater electrode 2501 is disposed in the vicinity of at least one of the branch waveguides 2103 and 2104. In FIG. 29, the heater electrode 2501 is disposed in the vicinity of the branch waveguide 2104. The heater electrode 2501 generates heat according to the applied power and heats the branch waveguide 2104. The refractive index of the heated branch waveguide 2104 changes due to the thermo-optical effect. By adjusting the amount of heat by controlling the power applied to the heater electrode 2501 and appropriately changing the refractive index of the branch waveguide 2104, the phase of the light propagating through the branch waveguide 2104 can be appropriately shifted.

The heater electrode 2501 is disposed so as to heat a specific branch waveguide 2104. However, the heat generated by the heater electrode 2501 may be transferred not only to the branch waveguide 2104 being heated, but also to other branch waveguides 2103, resulting in a problem of thermal crosstalk. For this reason, it is desirable to determine the positions at which the branch waveguides 2103 and 2104 are formed and the heater electrode 2501 is disposed so that other branch waveguides 2103 are not included within the heat conduction range R of the heater electrode 2501 (the heating range that can affect the refractive index).

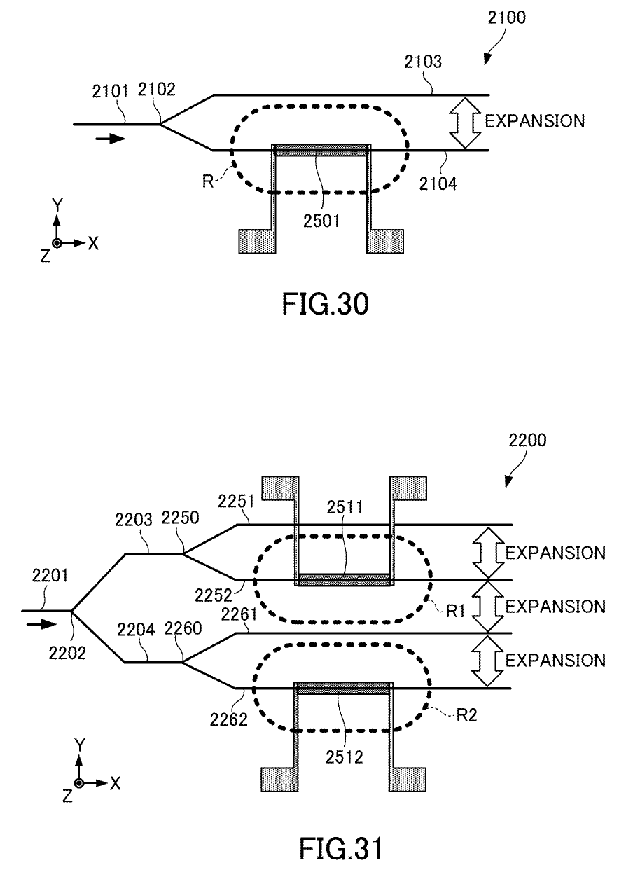

FIG. 30 schematically shows the two branch waveguides 2103 and 2104 with a large separation in the Y direction.

One possible way to prevent other branch waveguides 2103 from being included within the heat conduction range R of the heater electrode 2501 is to increase the separation distance between the branch waveguides 2103 and 2104 (separation distance in the Y direction in the figure), as shown in FIG. 30. However, increasing the separation distance in the Y direction causes a problem of increasing the overall length of the optical waveguide element in the Y direction. In the optical waveguide elements, the section to which high-frequency voltage is applied to modulate light must be lengthened, and a certain length is ensured, for example, along the X direction (first direction). Increasing the separation distance between the branch waveguides 2103 and 2104 in the Y direction leads to hindering efforts to reduce the size and increase the density of the optical waveguide element.

This problem is particularly pronounced when the optical waveguide element has multiple Mach-Zehnder optical waveguides. FIG. 31 shows a portion of a Mach-Zehnder optical waveguide 2200 in a nested structure (nested type), in which multiple Mach-Zehnder optical waveguides are nested. In the nested Mach-Zehnder optical waveguide 2200 shown in FIG. 31, a single input optical waveguide 2201 branches into two branch waveguides 2203 and 2204 at a first branching section 2202. The branch waveguide 2203 branches into two branch waveguides 2251 and 2252 at a second branching section 2250. The branch waveguide 2204 branches into two branch waveguides 2261 and 2262 at a third branching section 2260. Here, the combining sections located at the ends of each Mach-Zehnder optical waveguide are not shown.

In FIG. 31, as an example, a heater electrode 2511 is disposed on one branch waveguide 2252 branched at the second branching section 2250. A heater electrode 2512 is disposed on one branch waveguide 2262 branched at the third branching section 2260. The heater electrode 2511 heats the branch waveguide 2252 and has a thermal conduction range R1. The heater electrode 2512 heats the branch waveguide 2262 and has a thermal conduction range R2.

As one way to prevent other branch waveguides 2251, 2261, and 2262 from being included within thermal conduction range R1 and other branch waveguides 2251, 2252, and 2261 from being included within the thermal conduction range R2, it is considered to increase the separation distance (separation distance in the Y direction in the figure) between each branch waveguide 2251, 2252, 2261, and 2262, as shown in FIG. 31. However, increasing the separation distance between each branch waveguide 2251, 2252, 2261, and 2262 results in dramatically increasing the dimension in the Y direction (second direction).

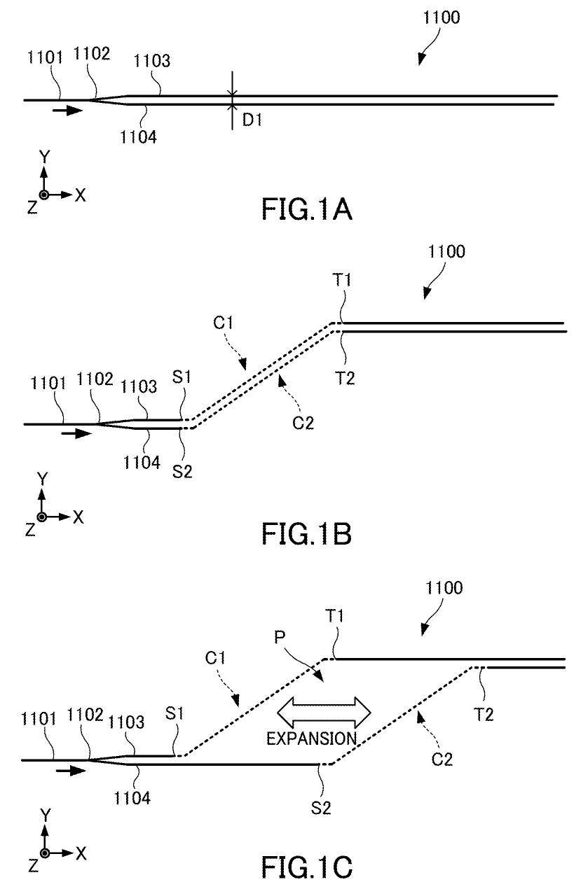

FIG. 1 is a diagram illustrating the basic concept of the present invention. FIG. 1A schematically shows branch waveguides 1103 and 1104 formed in a linear state. FIG. 1B schematically shows the branch waveguides 1103 and 1104 including curved waveguides C1 and C2. FIG. 1C schematically shows a portion of a Mach-Zehnder optical waveguide 1100 that reflects the basic concept of the present invention.

In the Mach-Zehnder optical waveguide 1100 shown in FIGS. 1A to 1C, a single input optical waveguide 1101 branches into two branch waveguides 1103 and 1104 at the branching section 1102. The combining section located at the end of the Mach-Zehnder optical waveguide is not shown. FIG. 1A shows the two branch waveguides 1103 and 1104 extending parallel to each other in the X direction. The distance D1 between the two parallel branch waveguides 1103 and 1104 is uniform.

In the present invention, the separation distance in the X direction between the two branch waveguides 1103 and 1104 is increased. Specifically, as shown in FIG. 1B, the curved waveguides C1 and C2 are formed in the branch waveguides 1103 and 1104, and the separation distance between the curved waveguides C1 and C2 is then expanded in the X direction as shown in FIG. 1C.

The curved waveguide C1 constitutes part of the branch waveguide 1103 and has a starting point S1 and an ending point T1. The starting point S1 and the ending point T1 are located at different positions in the Y direction, and the curved waveguide C1 includes an extension component in the Y direction between the starting point S1 and the ending point T1. The area in the vicinity of the starting point S1 of the curved waveguide C1 constitutes a second direction extension portion where the separation distance in the Y direction from the branch waveguide 1104 is increased.

The curved waveguide C2 constitutes part of branch waveguide 1104 and has a starting point S2 and an ending point T2. The curved waveguide C2 is formed to have the same shape as the curved waveguide C1. The starting point S2 and the ending point T2 are located at different positions in the Y direction, and the curved waveguide C2 includes an extension component in the Y direction between the starting point S2 and the ending point T2. The area in the vicinity of the ending point T2 of the curved waveguide C2 constitutes a second direction extension portion where the separation distance from the branch waveguide 1103 in the Y direction increases.

As shown in FIG. 1A, if the two branch waveguides 1103 and 1104 extend linearly in the X direction (i.e., if they do not include an extension component in the Y direction), the two branch waveguides 1103 and 1104 cannot be separated in the X direction. On the other hand, when the curved waveguides C1 and C2 identically shaped are provided on two branch waveguides 1103 and 1104 as shown in FIG. 1B, the two branch waveguides 1103 and 1104 can be separated in the X direction at the curved waveguides C1 and C2, as shown in FIG. 1C. In a region P formed between the curved waveguides C1 and C2, the curved waveguides C1 and C2 have portions that face each other in the X direction.

The curved waveguides C1 and C2 are arranged in the X direction to be separated by a predetermined distance or more. The X-direction separation distance between the curved waveguides C1 and C2 is preferably set appropriately based on the thermal conductivity range of the heater electrode. The thermal conductivity range of the heater electrode is determined based on various factors including the size, material, applied power, and other heating performance factors, as well as the thermal conductivity of the material that makes up the optical waveguide element.

The optical waveguide element according to the present invention is designed so that a heater electrode is disposed on at least one of the curved waveguides C1 and C2, and so that other branch waveguides are not formed within the thermal conduction range of the heater electrode. This allows other branch waveguides (e.g., branch waveguide 1103) to be formed outside the thermal conduction range of the heater electrode that heats a specific branch waveguide (e.g., branch waveguide 1104), thereby suppressing thermal crosstalk that may occur between the branch waveguides.

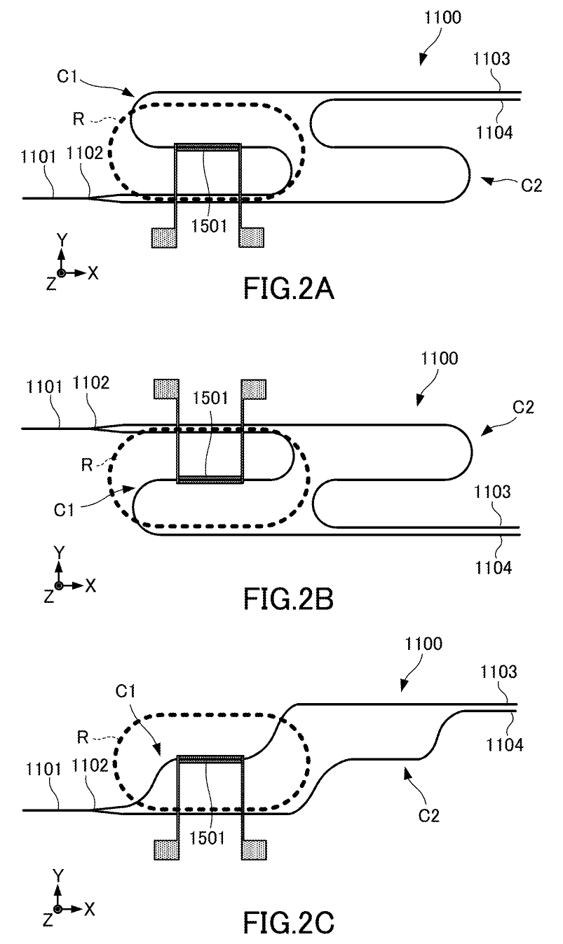

FIG. 2 shows an example of the curved waveguides C1 and C2 that form part of Mach-Zehnder optical waveguide 1100 embodying the basic concept of the present invention. Here, the combining section located at the end of the Mach-Zehnder optical waveguide is not shown. FIG. 2A shows the curved waveguides C1 and C2 as folded type waveguides formed in an S-shape. FIG. 2B shows the case where the curved waveguides C1 and C2 are folded type waveguides formed in an inverted S-shape. FIG. 2C shows the case where the curved waveguides C1 and C2 are serpentine waveguides. FIGS. 2A to 2C also show the heater electrode 1501 disposed on the curved waveguide C1 and its heat conduction range R.

The curved waveguide C1 includes a component extending in the Y direction in addition to a component extending in the X direction. At least a portion of the curved waveguide C1 is separated from other branch waveguides by a predetermined distance or more in both the X and Y directions.

The shapes of the curved waveguides C1 and C2 are not particularly limited. For example, the curved waveguides C1 and C2 can be used as the S-shaped folded type waveguide shown in FIG. 2A, the inverted S-shaped folded type waveguide shown in FIG. 2B, or the serpentine waveguide shown in FIG. 2C. However, it is preferable to use an S-shaped or inverted S-shaped folded type waveguide because of its ease of design and manufacturing and its advantages in terms of optical propagation efficiency.

The S-shaped or inverted S-shaped folded type waveguide refers to a structure in which N+1 straight portions extending in the X direction are alternately connected with N folded portions that reverse the extension direction of the optical waveguide by 180°. Here, N is a positive even number. The S-shaped folded type waveguide shown in FIG. 2A and the inverted S-shaped folded type waveguide shown in FIG. 2B are examples in which N=2.

In terms of suppressing thermal crosstalk, the shapes of the curved waveguides C1 and C2 do not necessarily have to be identical. For example, the curved waveguide C1 may be a folded type waveguide, and the curved waveguide C2 may be a serpentine waveguide. However, if the shapes or optical path lengths of the branch waveguides 1103 and 1104 are different, there is a possibility that differences in optical propagation loss, etc occur. For this reason, from the perspective of maintaining the symmetry of the branch waveguides 1103 and 1104, it is preferable that the curved waveguides C1 and C2 have the same shape. Furthermore, by making the curved waveguides C1 and C2 the same shape, it is possible to reliably position the curved waveguides C1 and C2 in face-to-face relationship with each other in the X direction.

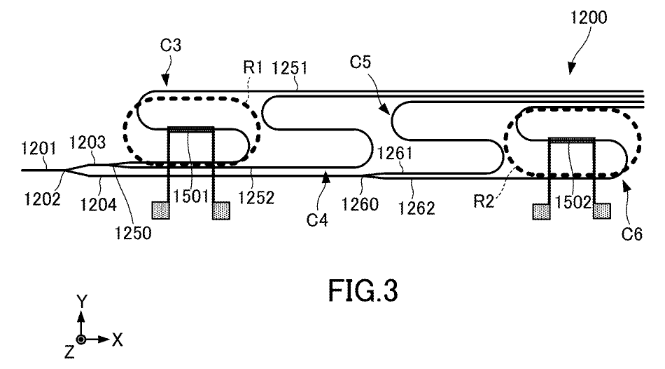

FIG. 3 shows an example of a portion of a nested Mach-Zehnder optical waveguide 1200 that reflects the basic concept of the present invention. In the nested Mach-Zehnder optical waveguide 1200 shown in FIG. 3, a single input optical waveguide 1201 branches into two branch waveguides 1203 and 1204 at a first branching section 1202. The branch waveguide 1203 branches into two branch waveguides 1251 and 1252 at a second branching section 1250. The branch waveguide 1204 branches into two branch waveguides 1261 and 1262 at a third branching section 1260. Here, the combining sections located at the ends of each Mach-Zehnder optical waveguide are not shown.

In FIG. 3, as an example, a heater electrode 1501 is disposed on one branch waveguide 1251 branched at the second branching section 1250. Additionally, a heater electrode 1501 is disposed on one branch waveguides 1262 branched at the third branching section 1260. The heater electrode 1501 heats the branch waveguide 1251 and has a thermal conduction range R1. A heater electrode 1502 heats branch waveguide 1262 and has a thermal conduction range R2.

As shown in FIG. 3, a curved waveguide C3 is formed in the branch waveguide 1251. A curved waveguide C4 is formed in the branch waveguide 1252. A curved waveguide C5 is formed in the branch waveguide 1261. A curved waveguide C6 is formed in the branch waveguide 1262. The curved waveguides C3 to C6 are composed of S-shaped folded type waveguides.

As a result, even in the nested Mach-Zehnder optical waveguide 1200, other branch waveguides 1252, 1261, and 1262 are prevented from being included within the thermal conduction range R1, and other branch waveguides 1251, 1252, and 1261 are prevented from being included within the thermal conduction range R2, thereby making it possible to suppress thermal crosstalk.

### First embodiment

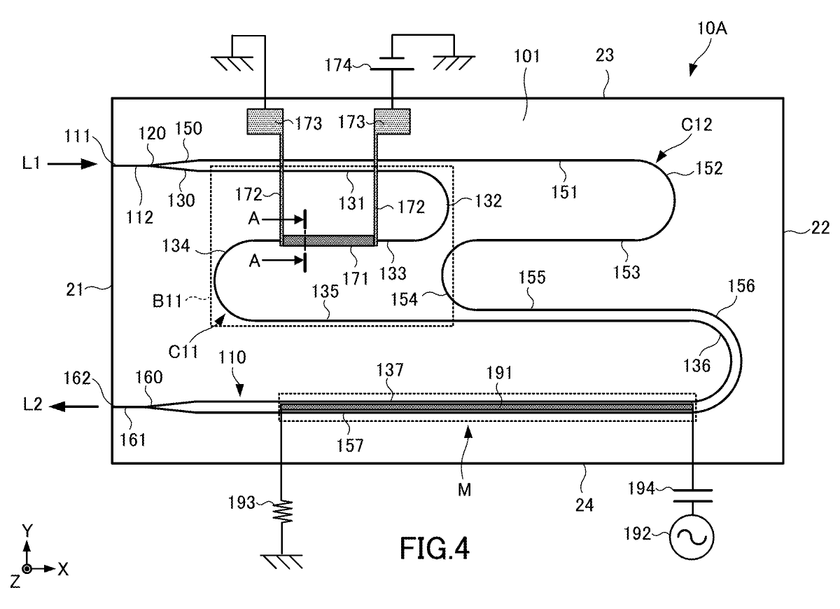

A first embodiment of the present invention will now be described. FIG. 4 is a plan view of an optical waveguide element 10A according to the first embodiment of the present invention. FIG. 5 is a cross-sectional view taken along line A-A in FIG. 4.

As shown in FIG. 4, the optical waveguide element 10A includes a substrate 101 and an optical waveguide 110 formed on the substrate 101. As will be described below, the optical waveguide 110 is formed, for example, by a convex portion 101a provided on the surface of the substrate 101.

As shown in FIG. 4, the optical waveguide element 10A is formed in a rectangular shape in a plan view. In this specification, the X direction in the plan view shown in FIG. 4 is referred to as the first direction of the optical waveguide element 10A, and the Y direction in the plan view shown in FIG. 4 is referred to as the second direction of the optical waveguide element 10A.

The optical waveguide element 10A shown in FIG. 4 is mounted on, for example, an optical modulator. The optical waveguide element 10A is configured to modulate incident light L1 incident on the optical input end 111 and emit output light L2 from the optical output end 162. In FIG. 4, the incident direction of incident light L1 is the positive X direction (first direction) in the figure, and the output direction of output light L2 is the negative X direction (first direction) in the figure.

In the optical waveguide element 10A shown in FIG. 4, the optical input end 111 and the optical output end 162 are located on the same end face (end face 21), but the optical input end 111 and the optical output end 162 may also be located on different end faces. The end face 21 and the end face 22 are located to face each other and constitute both ends of the optical waveguide element 10A in the first direction. The end face 23 and the end face 24 are located to face each other and constitute both ends of the optical waveguide element 10A in the short direction.

The optical waveguide element 10A is formed with an optical waveguide 110 that propagates light. The optical waveguide 110 is composed of an optical input end 111, an input optical waveguide 112, a branching section 120, branch waveguides 130 and 150, a combining section 160, an output optical waveguide 161, and an optical output end 162.

The optical input end 111 is the end of the optical waveguide 110 and functions as an optical input port that introduces incident light L1 into the optical waveguide 110. The optical input end 111 may be provided with a spot size converter (SSC) or a grading unit that changes the cross-sectional diameter of the light wave. The configuration of the spot size converter or grading unit is not particularly limited and can be realized using existing technology.

The input optical waveguide 112 has one end connected to the optical input end 111 and the other end connected to the branching section 120. The incident light L1 incident on the optical input end 111 is propagated to the branching section 120 through the input optical waveguide 112.

The branching section 120 is configured to branch the optical waveguide 110. For example, a Y-shaped waveguide or an optical coupler can be used for the branching section 120. The optical input side of the branching section 120 is connected to the input optical waveguide 112, and the optical output side is connected to the branch waveguides 130 and 150. The branching section 120 splits the light propagating through the input optical waveguide 112 into the branch waveguide 130 and the branch waveguide 150.

As shown in FIG. 4, a curved waveguide C11 is formed midway along the branch waveguide 130. In this embodiment, the curved waveguide C11 is a folded type waveguide with an inverted S-shape in plan view. More specifically, the curved waveguide C11 has, in order from the branching section 120 side (optical input side), a straight portion 131 extending in a first direction, a folded portion 132 formed in an arc shape, a straight portion 133 extending in the first direction, a folded portion 134 formed in an arc shape, and a straight portion 135 extending in the first direction. Connected to the rear side of the straight portion 135 are a folded portion 136 formed in an arc shape, and a straight portion 137 extending in the first direction. While the folded portions 132, 134, and 136 can have any curved shape, it is preferable to form them in an arc shape for achieving smooth connection to reduce optical loss. The term "arc-shaped" in this specification includes a circular curve having a transition curve at both ends of the circular curve. The transition curve is a curve designed to have a curvature changing gradually to smoothly connect a straight line and a circular line.

Similarly, a curved waveguide C12 is formed midway through the branch waveguide 150. The curved waveguide C12 in this embodiment is a folded type waveguide with an inverted S-shape in a planar view. More specifically, the curved waveguide C12 includes, in order from the branching section 120 side (light input side), a straight portion 151 extending in the first direction, a folded portion 152 formed in an arc shape, a straight portion 153 extending in the first direction, a folded portion 154 formed in an arc shape, and a straight portion 155 extending in the first direction. Connected to the rear side of the straight portion 155 is a folded portion 156 formed in an arc shape and a straight portion 157 extending in the first direction. While the folded portions 152, 154, and 156 can have any curved shape, it is preferable to form them in an arc shape for achieving smooth connection to reduce optical loss.

The curved waveguides C11 and C12 each include an extension component in the second direction in addition to an extension component in the first direction. Furthermore, the curved waveguides C11 and C12 are arranged to be spaced apart in the first direction with a predetermined distance or more. The folded portion 132 of the curved waveguide C11 constitutes a second direction extending portion where the separation distance from the branch waveguide 150 in the second direction increases. The folded portion 154 of the curved waveguide C12 constitutes a second direction extending portion where the separation distance from the branch waveguide 130 in the second direction increases. The second direction extending portion is an optical waveguide designed not to affect heat from the heater electrode arranged on one of the Mach-Zehnder optical waveguides (the branch waveguide) to the other of the Mach-Zehnder optical waveguides (the different branch waveguide) or other Mach-Zehnder optical waveguides.

Light traveling from the branching section 120 to the branch waveguide 130 propagates within the straight portion 131 in the positive X direction (first direction). The light travels in the negative Y direction (second direction) at the arc-shaped folded portion 132, then turns back, and propagates in the negative X direction (first direction) through the straight portion 133. The light travels in the negative Y direction (second direction) at the arc-shaped folded portion 134, then turns back again, and propagates in the positive X direction (first direction) through the straight portion 135. After turning back at the arc-shaped folded portion 136, the light propagates in the negative X direction (first direction) through the straight portion 137.

The light traveling from the branching section 120 to the branch waveguide 150 propagates in the positive X direction (first direction) through the straight portion 151. The light travels in the negative Y direction (second direction) at the arc-shaped folded portion 152, then turns back, and propagates in the negative X direction (first direction) through the straight portion 153. The light travels in the negative Y direction (second direction) at the arc-shaped folded portion 154, then turns back again, and propagates in the positive X direction (first direction) through the straight portion 155. After turning back at the arc-shaped folded portion 156, the light propagates in the negative X direction (first direction) through the straight portion 157.

The branch waveguide 130 and the branch waveguide 150 are connected to the combining section 160. The combining section 160 is configured to combine optical waveguides 110. The combining section 160 can use, for example, a Y-shaped waveguide, an optical coupler and the like. The optical input side of the combining section 160 is connected to the branch waveguide 130 and the branch waveguide150, and the optical output side of the combining section 160 is connected to the output optical waveguide 161. The light propagating through the branch waveguides 130 and the branch waveguide 150 is combined in the combining section 160.

The light waves combined in the combining section 160 propagate through the output optical waveguide 161 and are emitted as output light L2 from the optical output end 162 connected to the output optical waveguide 161.

The optical waveguide element 10A includes a bias control section B11 that adjusts the bias point of the light propagating through the optical waveguide 110, and a modulation section M that modulates the phase of the light propagating through the optical waveguide 110.

In this embodiment, the bias control section B11 is provided only for the branch waveguide 130. That is, in this embodiment, only the branch waveguide 130 is heated, and the branch waveguide 150 is not heated. By adjusting the bias point of the light propagating through the branch waveguide 130 by heating in the bias control section B11, the relative phase between the light propagating through the branch waveguide 130 and the light propagating through the branch waveguide 150 is adjusted.

The bias control section B11 has a heater electrode 171 that heats the optical waveguide 110. The heater electrode 171 is electrically connected to a wiring electrode 172 and an electrode pad 173, which function as a power supply line to the heater electrode 171. A DC power supply 174 is connected to the electrode pad 173.

The heater electrode 171 generates heat in response to the applied voltage and heats the branch waveguide 130, which is the heating target. In this embodiment, the heater electrode 171 is located in the vicinity of the straight portion 133 of the branch waveguide 130. The refractive index of the branch waveguide 130 heated by the heater electrode 171 changes due to the thermo-optical effect. By controlling the voltage applied to the heater electrode 171, the amount of heat (temperature) of the branch waveguide 130 is adjusted, thereby resulting in enabling to appropriately adjust the phase shift of the light. The heater electrode 171 may be made of the same metal as the modulation section M, or a metal with excellent heat generation efficiency and heat resistance may be selected.

The optical waveguide 110 formed in the optical waveguide element 10A is a Mach-Zehnder optical waveguide that branches into two branch waveguides 130 and 150 at the branching section 120. The modulation section M is provided at the rear side of the bias control section B11. The modulation section M modulates the light branched into the two branch waveguides 130 and 150 at the branching section 120 to control the phase of each light, thereby making it possible to appropriately adjust the intensity (signal intensity) of the light combined in the combining section 160.

The electrode structure of the modulation section M is outside the scope of this invention and is not particularly limited. FIG. 4 shows a schematic diagram of a control electrode 191 disposed in the vicinity of the straight portions 137 and 157 of the branch waveguides 130 and 150, and electrically connected to a high-frequency signal source (high-frequency power supply) 192 and a termination resistor 193. The control electrode 191 may be configured to include a signal electrode and a reference electrode (ground electrode). In the case of an X-cut substrate, the signal electrode is preferably disposed to the side of the straight portions 137 and 157. In the case of a Z-cut substrate, the signal electrode is preferably disposed directly above the straight portions 137 and 157. A capacitor 194 may be interposed between the control electrode 191 and the high-frequency signal source 192 to cut the DC component of the high-frequency signal source 192. However, if a DC component is applied to the control electrode 191, the capacitor 194 need not be interposed. The termination resistor 193 and the capacitor 194 may be mounted or formed on the optical waveguide device 10A.

With reference to FIG. 5, the cross-sectional structure of the optical waveguide element 10A in this embodiment will now be described. FIG. 5 illustrates a cross section in the vicinity of the straight portion 133 of the branch waveguide 130. In FIG. 5, the left-right direction (Y direction) of the cross-section corresponds to the second direction of the optical waveguide element 10A, and the up-down direction (Z direction) corresponds to the height direction of the optical waveguide element 10A.

The substrate 101 of the optical waveguide element 10A is made of a material having an electro-optical effect. Examples of materials having an electro-optical effect include lithium niobate (LN), lithium tantalate (LT), lead lanthanum zirconate titanate (PLZT), EO polymer and the like. These materials may be doped with MgO or the like. Vapor-deposited films made of these materials, or composite substrates in which these materials are bonded to a different kind of substrate, may also be used.

The thickness of the substrate 101 is preferably, for example, 1.0 μm or less. The thickness of the substrate 101 refers to the height from the bottom surface of the substrate 101 to the flat upper surface of the substrate where the convex portions 101a are not formed. By forming the substrate 101 as a thin film with a thickness of 1.0 μm or less, it is possible to reduce the driving voltage and achieve miniaturization.

The optical waveguide 110 is formed on the substrate 101 of the optical waveguide element 10A. The substrate 101 is formed with convex portions 101a that protrude from the flat upper surface of the substrate. The convex portions 101a are provided in areas corresponding to the optical waveguide 110 and form a convex optical waveguide, which is a path (optical path) along which light propagates.

The method for forming the convex optical waveguide is not particularly limited. For example, the substrate 101 may be etched to leave the convex portion 101a (rib portion), or the convex portion 101a (ridge portion) may be formed by removing a portion of both sides of the optical waveguide 110 to form a concave cut portion 101b. Instead of a convex optical waveguide, a thermal diffusion type waveguide may be formed by diffusing Ti or the like onto the surface of the substrate 101 using a thermal diffusion method, or a proton exchange type waveguide may be formed by diffusing Ti or the like onto the surface of the substrate 101 using a proton exchange method. Furthermore, the refractive index may be further increased by forming a convex optical waveguide and then diffusing Ti or the like onto the surface of the substrate 101 using a thermal diffusion method or a proton exchange method. The size of the convex portion 101a is not particularly limited, but the width and height can be approximately 1.0 μm, similar to a typical convex optical waveguide. Here, as shown in FIG. 5, the convex portion 101a is formed by forming a cut portion 101b.

As shown in FIG. 5, a reinforcing substrate (support substrate) 102 may be disposed below the substrate 101 to increase the mechanical strength of the thinned substrate 101. Here, the lower portion of the reinforcing substrate 102 is not shown in FIG. 5. The thickness of the reinforcing substrate 102 is not particularly limited, but can be, for example, approximately 0.2 to 1.0 mm. The reinforcing substrate 102 may be bonded to the substrate 101 through a bonding layer (intermediate layer) 103, as shown in FIG. 5, or may be bonded directly to the substrate 101. The material of the reinforcing substrate 102 is not particularly limited, but for example may include Si, glass, quartz, fused quartz, synthetic quartz, alkali glass, alkali-free glass, lead glass, borosilicate glass, soda glass, sapphire, and alumina.

As shown in FIG. 5, a heater electrode 171 is placed on the substrate 101. In FIG. 5 , cut portions 101b are formed on both sides of the straight portion 133 of the branch waveguide 130, and heater electrodes 171a and 171b are disposed within the cut portions 101b. The heater electrodes 171a and 171b are electrically connected to form the heater electrode 171. To suppress light absorption by the heater electrode 171, the heater electrode 171 is preferably disposed so as not to be held in contact with the convex portion 101a that forms the optical waveguide 110.

The heating performance of the heater electrode 171 is determined by the combination of factors including the size of the heater electrode 171, the applied voltage and the like. The size of the heater electrode 171 is preferably set to provide adequate heating performance for heating the branch waveguide 130. For example, the heater electrode 171 has a length of several micrometers along the branch waveguide 130 to be heated. The width and height of the heater electrode 171 can be appropriately determined to match the size of the convex portion 101a.

In FIG. 5, the heater electrodes 171 are arranged on both sides of the straight portion 133 of the branch waveguide 130 so as to sandwich the straight portion 133 of the branch waveguide 130. However, this form is not limited.

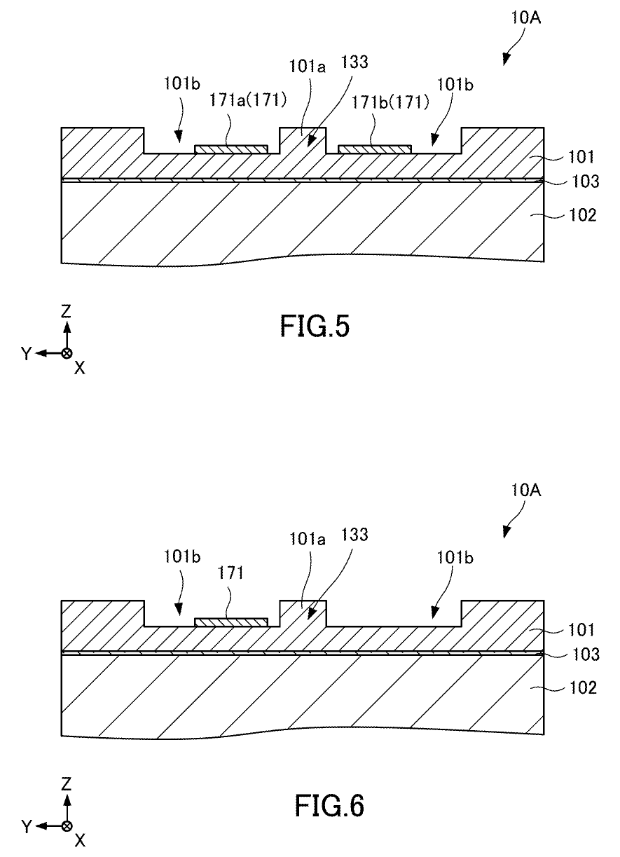

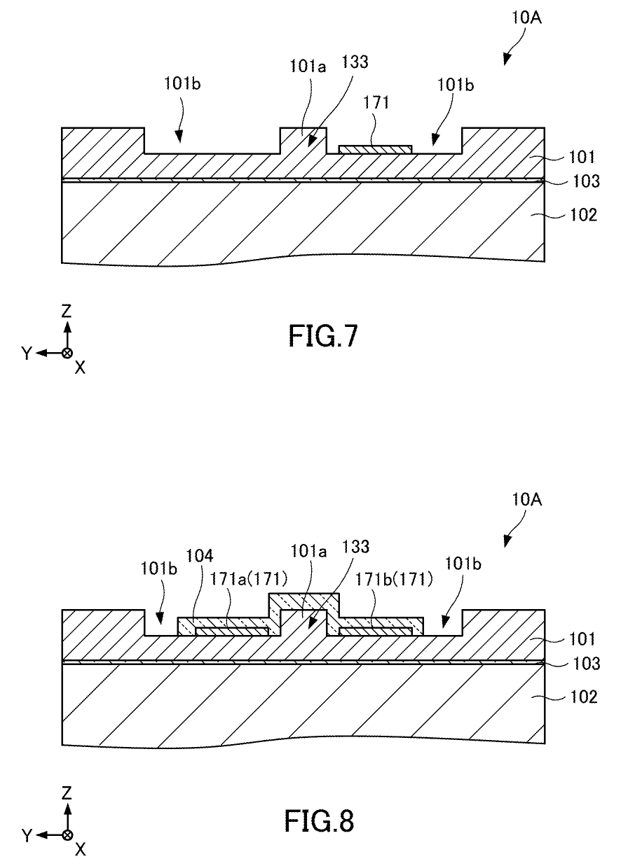

The heater electrode 171 may be arranged on only one side of the branch waveguide 130 to be heated. For example, as shown in FIG. 6, the heater electrode 171 may be arranged on one side of the straight portion 133 of the branch waveguide 130 (the positive Y-direction side relative to the convex portion 101a). Alternatively, as shown in FIG. 7, the heater electrode 171 may be arranged on the other side of the straight portion 133 of the branch waveguide 130 (the negative Y-direction side relative to the convex portion 101a).

A buffer layer 104 may be arranged on part or the entire upper surface of the substrate 101. By disposing the buffer layer 104 to cover the convex portion 101a, the light confinement effect in the convex portion 101acan be improved. Furthermore, by disposing the buffer layer 104 to cover the entire upper surface of the substrate 101, the entire upper surface of the substrate 101 can be protected. In particular, it is preferable to place the buffer layer 104 at the intersection of the wiring electrode 172 and the optical waveguide 110 to prevent direct contact between the wiring electrode 172 and the optical waveguide 110. The buffer layer 104 is made of a material with a lower refractive index than the substrate 101, such as SiO₂. While the waveguide is illustrated as having a convex shape, the optical waveguide 110 may have a rectangular or other shape.

In the configuration shown in FIG. 8, the buffer layer 104 is disposed on the upper surface of the substrate 101 so as to cover the convex portion 101a and the heater electrode 171. FIG. 8 shows an example in which a buffer layer 104 is disposed in a configuration in which heater electrodes 171 are disposed on both sides of the straight portion 133 of the branch waveguide 130 (the configuration shown in FIG. 5 above). However, similarly to a configuration in which the heater electrode 171 is disposed on one side of the straight portion 133 of the branch waveguide 130 (the configurations shown in FIGS. 6 and 7 above), the buffer layer 104 can be disposed so as to cover the convex portion 101a and the heater electrode 171.

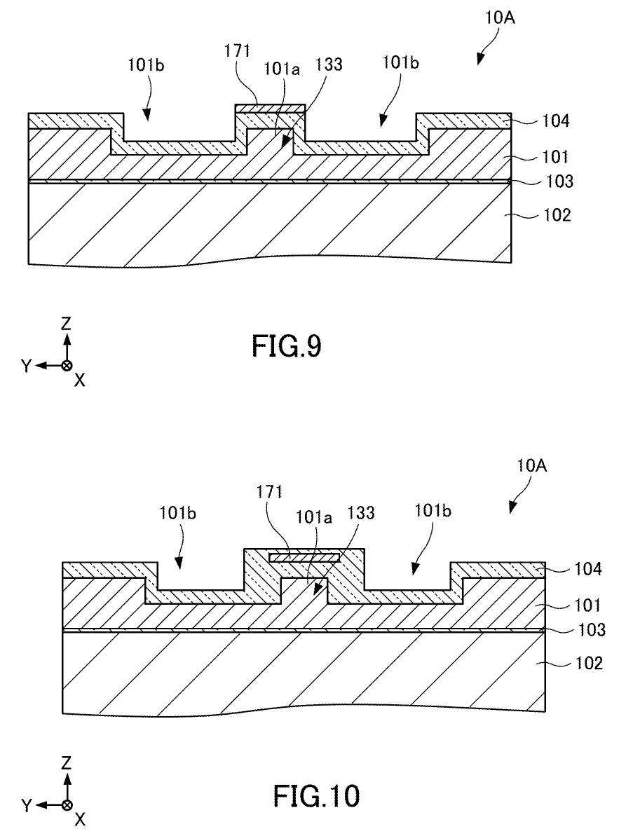

In the configuration shown in FIGS. 9 and 10, the buffer layer 104 is disposed so as to cover the entire upper surface of the substrate 101. As shown in FIG. 9, the heater electrode 171 may be disposed on the upper surface of the buffer layer 104. For example, the heater electrode 171 is disposed on the buffer layer 104 so as to be located above the convex portion 101a. In this case, the upper surface of the heater electrode 171 can be exposed to the outside (air), improving heat dissipation efficiency after heating.

As shown in FIG. 10, the heater electrode 171 may be embedded in the buffer layer 104. The heater electrode 171 is embedded in the buffer layer 104 so as to be located above the convex portion 101a, for example. In this case, the heater electrode 171 and the convex portion 101a are positioned closer to each other, thereby making it possible to improve the heating efficiency of the optical waveguide 110.

Furthermore, in FIG. 4, the heater electrode 171 is disposed in the vicinity of the straight portion 133 that constitutes the curved waveguide C11. However, the heater electrode 171 may be disposed away from the other branch waveguides 150 so as to make the other branch waveguides 150 not included in the heat conduction range.

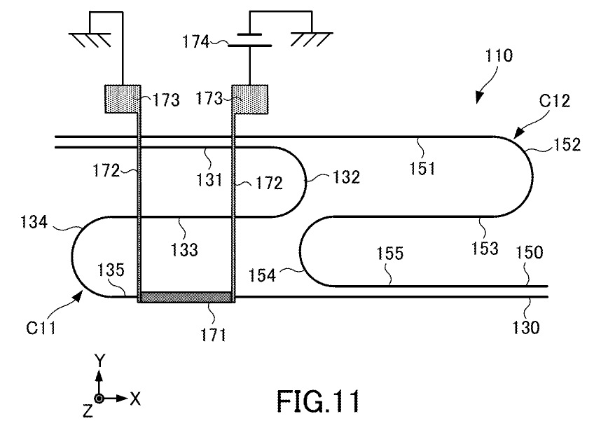

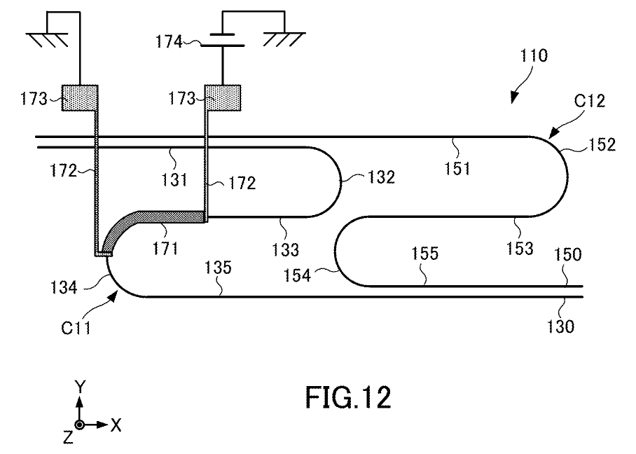

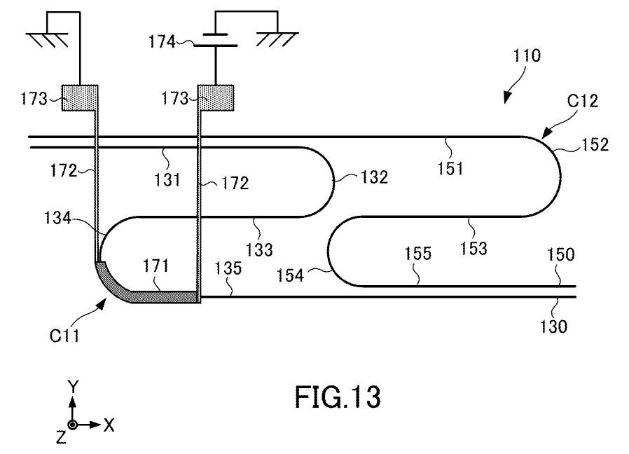

For example, as shown in FIG. 11, the heater electrode 171 may be disposed in the vicinity of the straight portion 135 that constitutes the curved waveguide C11. When the straight portion 135 is heated, the thermo-optical effect of the heater electrode 171 can be applied evenly and efficiently. Alternatively, as shown in FIGS. 12 and 13, the heater electrode 171 may be disposed in the vicinity of the folded portion 134 that constitutes the curved waveguide C11. In FIG. 12, the heater electrode 171 is disposed in the vicinity of both the straight portion 133 and the folded portion 134. In FIG. 13, the heater electrode 171 is disposed in the vicinity of both the folded portion 134 and the straight portion 135.

The extension direction and shape of the heater electrode 171 can be set arbitrarily. The heater electrode 171 may be shaped to extend in the X direction or the Y direction, or may be shaped to extend at a predetermined angle (diagonal) relative to the X and Y directions. The heater electrode 171 may also be linear, curved, or a combination of linear and curved shapes. Furthermore, the heater electrode 171 may be divided into multiple linear or curved electrodes that are electrically connected.

The bias control section B11 will now be described.

The heat generated by the heater electrode 171 is diffused within a predetermined thermal conduction range (a heating range that can affect the refractive index), for example, centered on the heater electrode 171. For this reason, when a specific optical waveguide (branch waveguide 130) is to be heated, the heater electrode 171 must be disposed so that the heat generated by the heater electrode 171 does not reach other optical waveguides (branch waveguides 150).

The bias control section B11 is set at the position where the curved waveguide C11 is formed, and the heater electrode 171 is disposed on the curved waveguide C11. As shown in FIG. 4, the curved waveguide C11 is configured to include a straight portion 131, a folded portion 132, a straight portion 133, a folded portion 134, and a straight portion 135, and is formed to be an inverted-S-shaped folded type waveguide in a planar view.

The curved waveguide C11 includes an extension component not only in the first direction but also in the second direction. Specifically, the inverted-S-shaped folded type waveguide that constitutes the curved waveguide C11 is curved in the XY plane and includes an extension component in both the first and second directions. This allows a portion of the curved waveguide C11 to be separated from the other branch waveguide 150 by a predetermined distance or more in both the first and second directions. By placing a heater electrode 171 at this separated portion, the other branch waveguide 150 cannot be included in the thermal conduction range of the heater electrode 171. In this embodiment, at least a portion of the straight portion 133 of the curved waveguide C11 is the above-mentioned separated portion, and the heater electrode 171 is disposed at this portion.

Furthermore, the curved waveguides C11 and C12 have the same shape and are arranged in the X direction. Specifically, the folded portion 132 and the folded portion 152 are curved in the same direction (negative Y direction) from the straight portion 131 and the straight portion 151, respectively. If the folded portion 132 and the folded portion 152 were curved in opposite directions, the optical waveguide 110 expands in the second direction, thereby resulting in hindering the miniaturization and high density of the optical waveguide element 10A. In contrast, by curving the curved waveguides C11 and C12 in the same direction, the optical waveguide element 10A can be miniaturized and high density. Furthermore, the curved waveguides C11 and C21 takes respective states to have portions that face each other in the X direction, allowing the curved waveguides C11 and C12 to be spaced apart by a predetermined distance or more while being in the states aligned in the X direction.

### Second embodiment

The optical waveguide element 10B according to the second embodiment will now be described. The optical waveguide element 10B differs from the optical waveguide element 10A in that grooves 210 and 220 are formed between the branch waveguides to shield the heat generated by the heater electrode 171. The constitution elements with similar functions to those in the above-described embodiments are designated by the same reference numerals, and their descriptions will be simplified or omitted.

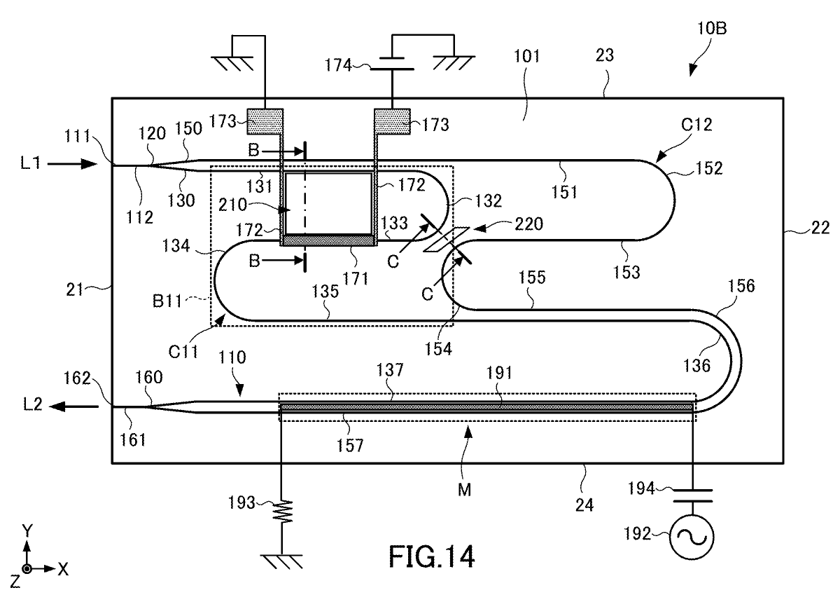

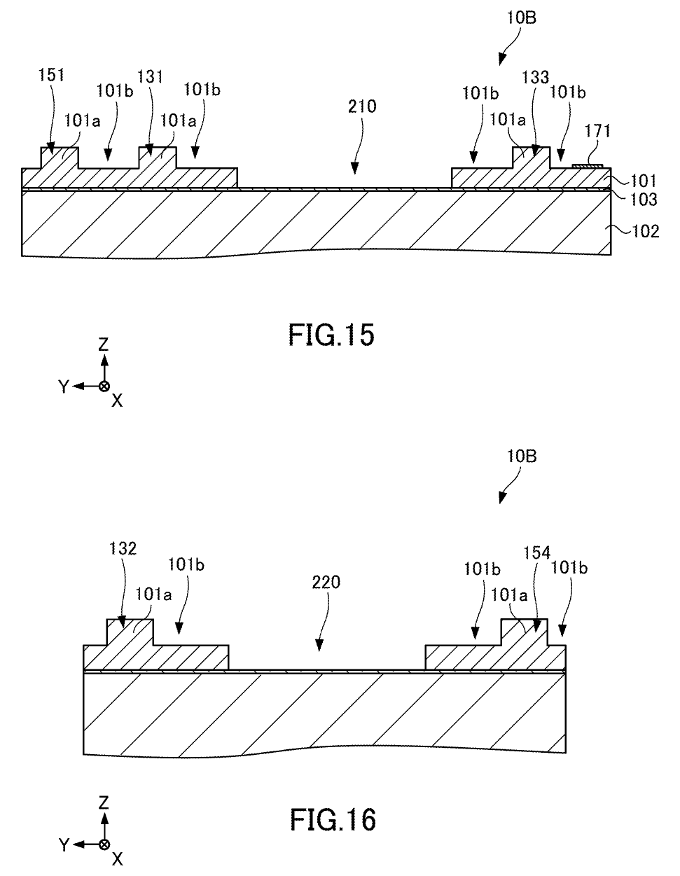

FIG. 14 is a plan view of the optical waveguide element 10B according to the second embodiment of the present invention. FIG. 15 is a cross-sectional view taken along line B-B in FIG. 14. FIG. 16 is a cross-sectional view taken along line C-C in FIG. 14.

Heat generated by the heater electrode 171 may possibly be conducted through the substrate 101 and diffuse in the planar directions (X and Y directions). In the optical waveguide element 10B of the second embodiment, as shown in FIG. 14, grooves 210 and 220 are formed in the substrate 101 to prevent heat from diffusing through the substrate 101. The optical waveguide element 10B shown in FIG. 14 has multiple grooves 210 and 220, but only one of the grooves 210 and 220 may be formed.

The grooves 210 and 220 are formed by cutting and removing a portion of the substrate 101. The grooves 210 and 220 are formed between the heater electrode 171 that heats the branch waveguide 130 to be heated and the other branch waveguide 150 different from the branch waveguide 130. The grooves 210 and 220 remove part of the heat conduction path (a part of the substrate 101), thereby blocking heat conduction from the heater electrode 171. In other words, the grooves 210 and 220 have a heat-shielding effect, thereby narrowing the heat conduction range of the heater electrode 171.

As shown in FIG. 15, the groove 210 is formed between the heater electrode 171 that heats the straight portion 133 of the branch waveguide and the straight portion 151 of the other branch waveguide. The presence of the groove 210 results in preventing heat generated at the heater electrode 171 from being transmitted to the straight portion 151 of the other branch waveguide.

As shown in FIG. 16, the groove 220 is formed between the folded portion 132 of the branch waveguide and the folded portion 154 of the other branch waveguide. The presence of the groove 220 results in preventing heat generated at the heater electrode provided in the branch waveguide from being transmitted to the folded portion 154 of the other branch waveguide.

In the configuration shown in FIG. 16, a groove 220 is formed between the folded portion 132 of the branch waveguide 130 and the folded portion 154 of the branch waveguide 150. The groove 220 is located at a position that is approximately equidistantly spaced apart between the adjacent folded portions 132 and 154. The heater electrode 171 is provided in the vicinity of the straight portion 133 of the branch waveguide 130. As shown in FIG. 16, by positioning the groove 220 between the heater electrode 171 that heats the branch waveguide 130 and the folded portion 154 of the other branch waveguide 150, heat generated by the heater electrode 171 can be prevented from being transmitted to the other branch waveguide 150.

The size of the grooves 210 and 220 is not particularly limited. Although larger grooves 210, 220 can better prevent heat diffusion, even small grooves 210, 220 can exhibit a heat-shielding effect. The grooves 210, 220 are open to the outside and are filled with air. Air has high thermal insulation properties, and air-filled grooves 210, 220 have excellent heat insulation properties. A portion of substrate 101 may remain at the bottom of grooves 210, 220, or the bonding layer 103 or reinforcing substrate 102 may be exposed. Furthermore, the grooves may be formed in reinforcing substrate 102.

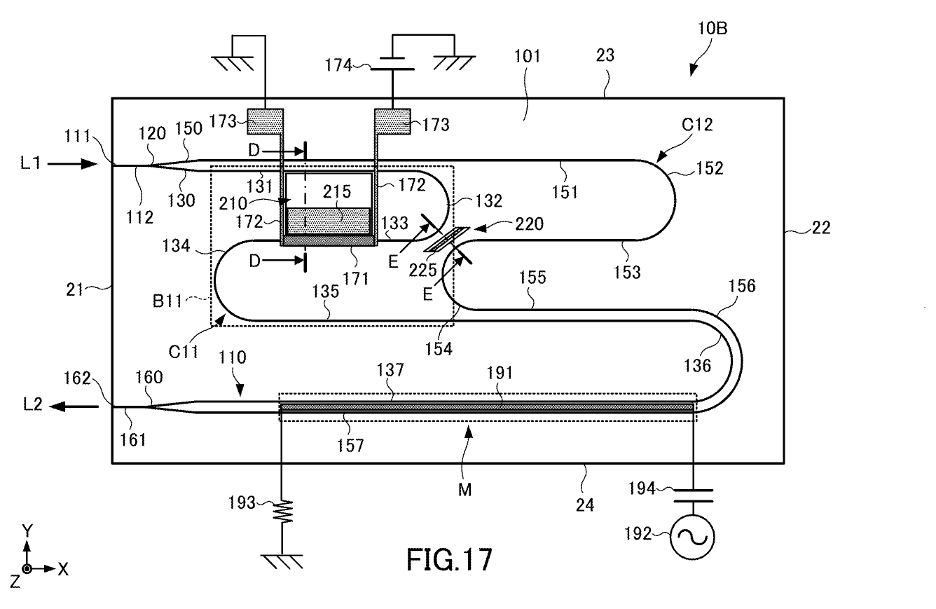

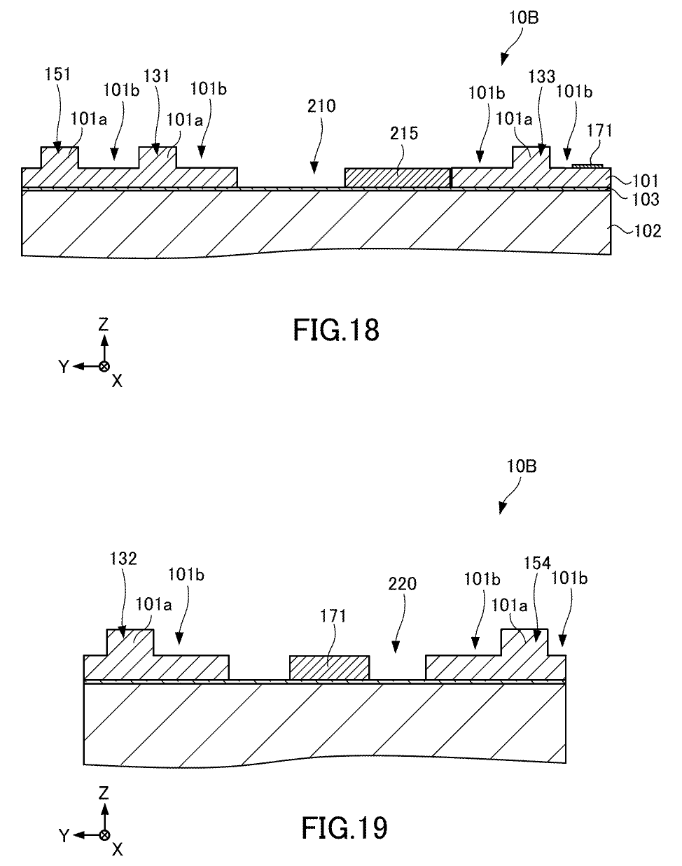

FIG. 17 is a plan view of an optical waveguide element 10B according to a derivative example of the second embodiment of the present invention. FIG. 18 is a cross-sectional view taken along line D-D in FIG. 17. FIG. 19 is a cross-sectional view taken along line E-E in FIG. 17.

As shown in FIG. 17, the heat dissipation materials 215, 225 may be disposed within the respective grooves 210, 220. The heat dissipation materials 215, 225 dissipate heat to the outside and have a function to prevent performance degradation and malfunctions due to overheating. The heat dissipation materials 215, 225 may be made of a metal with a low specific heat capacity, for example. By providing the heat dissipation materials 215, 225, thermal energy accumulated during and after heating can be released to the outside. The exposed surfaces of the heat dissipation materials 215, 225 are held in contact with the external air. Providing an uneven shape (e.g., a rough surface) on these exposed surfaces may increase the surface area in contact with the air, thereby improving the heat dissipation effect.

The heat dissipation materials 215, 225 may be disposed in only a portion of the grooves 210, 220, or may be disposed throughout the entire grooves 210, 220. FIGS. 16 to 18 each shows a state in which the heat dissipation materials 215, 225 are disposed in part of grooves 210, 220.

In the case that the heat dissipation materials 215, 225 are disposed in part of grooves 210, 220, there are no particular restrictions on the arrangement position of the heat dissipation materials 215, 225 within the grooves 210, 220. In the groove 210 shown in FIG. 18, the heat dissipation material 215 is disposed in the vicinity of the heater electrode 171. In this case, air is filled inside the groove 210 located away from heater electrode 171.

FIG. 18 shows an example in which a groove 220 is formed in a configuration (see FIG. 7) in which the heater electrode 171 is provided on one side of the straight portion 133 of the branch waveguide 130. However, the grooves 220 may also be formed in a configuration (see FIG. 6) in which the heater electrode 171 is provided on one side of the straight portion 133 of the branch waveguide 130 or on both sides (see FIG. 8). In either case, the grooves 220 can suppress heat diffusion, and the placement of the heat dissipation materials 215, 225 can improve heat dissipation.

Furthermore, in the groove 220 shown in FIG. 19, the heat dissipation material 225 is disposed approximately in the center of the groove 220. In this case, air is filled inside the grooves 210 on both sides of the heater electrode 171, i.e., on the side closer to and the side farther from the heater electrode 171.

Although FIGS. 18 and 19 show a configuration in which the buffer layer 104 is not provided on the upper surface of the substrate 101, a configuration in which the buffer layer 104 is provided may also be used. If the buffer layer 104 is provided, it is preferable to expose the heat dissipation materials 215, 225 to the outside without covering their upper surfaces with the buffer layer 104. This makes it possible to maintain the heat dissipation effect of the heat dissipation materials 215, 225.

Here, the heat dissipation materials 215, 225 are disposed within the grooves 210, 220, but the heat dissipation materials 215, 225 may be placed on the substrate 101 without providing the grooves 210, 220.

### Third embodiment

The optical waveguide element 10C in the third embodiment will now be explained hereinafter. The optical waveguide element 10C differs from the optical waveguide element 10A in that the heater electrodes 171, 181 are disposed on both the branch waveguide 130 and the branch waveguide 150, respectively. The constitution elements having the same functions as those in the above-described embodiments are designated by the same reference numerals, and descriptions thereof will be simplified or omitted.

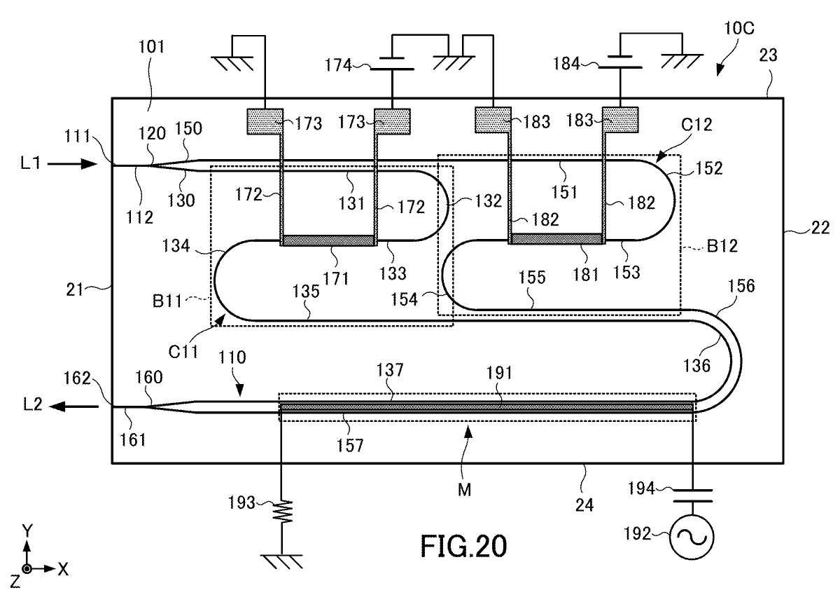

FIG. 20 is a plan view of the optical waveguide element 10C according to the third embodiment of the present invention. The optical waveguide element 10C shown in FIG. 20 is provided with a bias control section B11, which adjusts the bias point of light propagating through branch waveguide 130, and a bias control section B12, which adjusts the bias point of light propagating through the branch waveguide 150.

The bias control section B12 has a heater electrode 181. A wiring electrode 182 and an electrode pad 183 are electrically connected to the heater electrode 181. The electrode pad 183 is connected to a DC power supply 184.

The heater electrode 181 generates heat in response to the applied voltage to heat the branch waveguide 150, which is the heating target. The refractive index of the branch waveguide 150 heated by the heater electrode 181 changes due to the thermo-optical effect. By controlling the voltage applied to the heater electrode 181, the amount of heat (temperature) of the branch waveguide 130 can be adjusted, thereby appropriately adjusting the phase shift of the light.

As shown in FIG. 20, the curved waveguides C11 and C12 are constituted by folded type waveguides having the same shape and are arranged in the X direction. The heater electrode 171 heats the branch waveguide 130. By placing the heater electrode 171 in the vicinity of the straight portion 133, which is part of the curved waveguide C11, it is possible to prevent other branch waveguides 150 from being included in the heat conduction range of the heater electrode 171. The heater electrode 181 also heats the branch waveguide 150. By arranging the heater electrode 181 in the vicinity of the straight portion 153 that is part of the curved waveguide C12, it is possible to prevent other branch waveguides 130 from being included in the heat conduction range of the heater electrode 181.

In FIG. 20, the heater electrode 171 is disposed in the vicinity of the straight portion 133 that constitutes the curved waveguide C11, and the heater electrode 181 is disposed in the vicinity of the straight portion 153 that constitutes the curved waveguide C12. The heater electrodes 171 and 181 may be disposed to extend in the same direction. Furthermore, the other heater electrode 181 may be disposed on a straight line extending in the first direction in which one of the heater has the width of the short side, i.e., the short sides of the heater electrodes 171 and 181 may face each other. As a result, the heat generated by the heater electrode 171 is received by the short side of the other heater electrode 181, which can reduce the effects of thermal crosstalk as compared with, for example, a configuration in which the long sides of one heater electrode 171 and the other heater electrode 181 face each other, i.e., the heat generated by the heater electrode 171 is received by the long side of the other heater electrode 181. Here, "on a line extending in the first direction and having the width of the short side of one heater electrode" includes a configuration in which at least a portion of the short side of the other heater electrode overlaps with a line having the width of the short side of one heater electrode. For example, the overlap ratio (Wop) of the widths of the short sides of the heater electrodes can be Wop < 50%, 50 ≤ Wop < 100%, or Wop = 100%. Also, in FIG. 20, the heater electrodes 171 and 181 are both disposed to extend in the X direction, but the heater electrodes 171 and 181 may also be disposed to extend in the Y direction, or further disposed to extend at a predetermined angle (diagonal) with respect to the X direction and the Y direction.

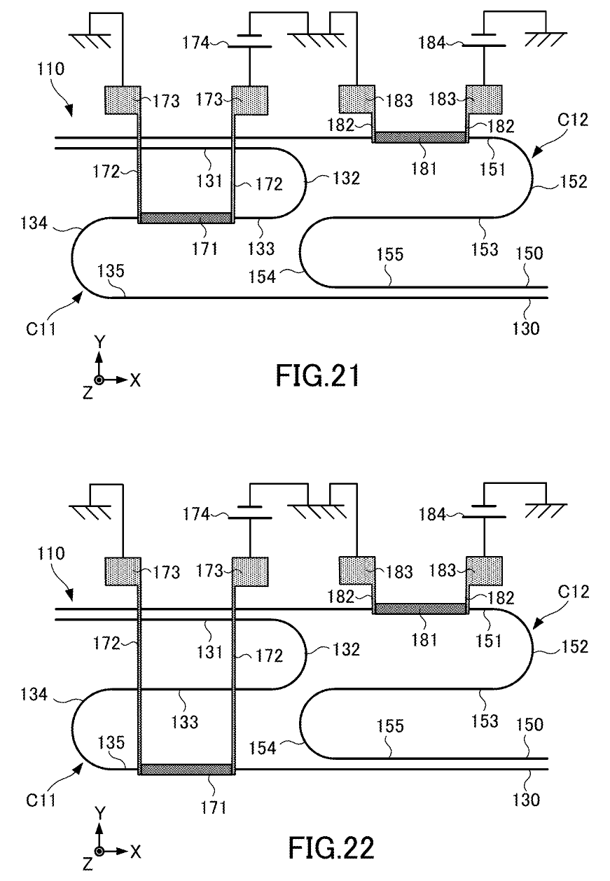

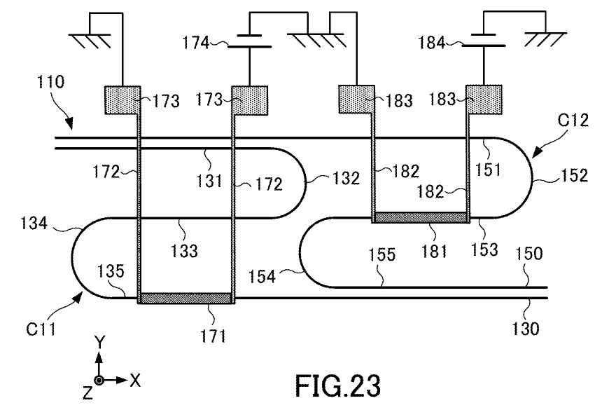

The placement positions of the heater electrodes 171, 181 are not limited to the embodiment shown in FIG. 20. FIGS. 21 to 23 show first to third placement examples of the heater electrodes 171, 181. FIGS. 21 to 23 are partial plan views showing the area corresponding to the vicinity of the curved waveguides C11 and C12 in FIG. 20. For example, as shown in FIG. 21, the heater electrode 171 may be disposed in the vicinity of the straight portion 133 that constitutes the curved waveguide C11, and the heater electrode 181 may be disposed in the vicinity of the straight portion 151 that constitutes the curved waveguide C12. Alternatively, as shown in FIG. 22, the heater electrode 171 may be disposed in the vicinity of the straight portion 135 that constitutes the curved waveguide C11, and the heater electrode 181 may be disposed in the vicinity of the straight portion 151 that constitutes the curved waveguide C12. Also, as shown in FIG. 23, for example, the heater electrode 171 may be disposed in the vicinity of the straight portion 135 of the curved waveguide C11, and the heater electrode 181 may be disposed in the vicinity of the straight portion 153 of the curved waveguide C12. For example, in FIGS. 21 to 23, both the heater electrodes 171 and 181 are disposed to extend in the X direction, but the heater electrodes 171 and 181 may also be disposed to extend in the Y direction, or may be disposed at a predetermined angle (diagonal) with respect to the X direction and the Y direction. Furthermore, the heater electrode 181 may be disposed in the vicinity of both the straight portion 153 and the folded portion 152, or may be disposed in the vicinity of both the straight portion 151 and the folded portion 152.

### Fourth embodiment

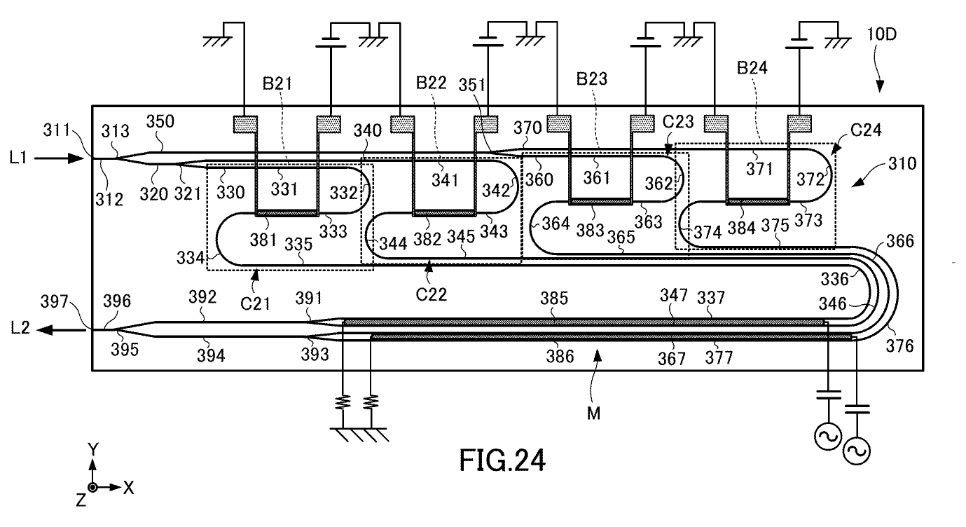

The optical waveguide element 10D according to the fourth embodiment will now be described. FIG. 24 is a plan view of an optical waveguide element 10D according to the fourth embodiment of the present invention. The optical waveguide element 10D in the fourth embodiment is configured to include multiple Mach-Zehnder optical waveguides. The constitution elements having the same functions as those in the above-described embodiments are designated by the same reference numerals, and descriptions thereof will be simplified or omitted.

The optical waveguide element 10D includes an optical waveguide 310 for propagating light. The optical waveguide 310 is a nested type of Mach-Zehnder optical waveguide having a nest structure. The optical waveguide element 10D is configured to include an optical input end 311, an input optical waveguide 312, branching sections 313, 321, and 351, branch waveguides 320, 330, 340, 350, 360, and 370, a combining section 395, an output optical waveguide 396, and an optical output end 397.

The input optical waveguide 312 connected to the optical input end 311 branches into the branch waveguide 320 and the branch waveguide 350 at the branching section 313. The branch waveguide 320 branches into the branch waveguide 330 and the branch waveguide 340 at the branching section 321. The branch waveguide 350 branches into the branch waveguide 360 and the branch waveguide 370 at the branching section 351.

As shown in FIG. 24, a curved waveguide C21 is formed midway through the branch waveguide 330. The curved waveguide C21 in this embodiment is a folded type waveguide that is an inverted S-shaped in a planar view. More specifically, the curved waveguide C21 includes, in order from the branching section 321 side (light input side), a straight portion 331 extending in the first direction, a folded portion 332 formed in an arc shape, a straight portion 333 extending in the first direction, a folded portion 334 formed in an arc shape, and a straight portion 335 extending in the first direction. The rear side of the straight portion 335 is connected with a folded portion 336 formed in an arc shape and a straight portion 337 extending in the first direction. The folded portions 332, 334, and 336 can have any curved shape, but preferably are in an arc shape to achieve smooth connecting to reduce optical loss.

As shown in FIG. 24, a heater electrode 381 of the bias control section B21 is disposed in the vicinity of the straight portion 333 constituting the curved waveguide C21. A control electrode 385 of the modulation section M is disposed in the vicinity of the straight portion 337.

Similarly, a curved waveguide C22 is formed midway through the branch waveguide 340. The curved waveguide C22 in this embodiment has the same shape as the curved waveguide C21. The curved waveguide C21 has, in order from the branching section 321 side (light input side), a straight portion 341 extending in a first direction, a folded portion 342 formed in an arc shape, a straight portion 343 extending in the first direction, a folded portion 344 formed in an arc shape, and a straight portion 345 extending in the first direction. Connected to the rear side of the straight portion 345 are a folded portion 346 formed in an arc shape and a straight portion 347 extending in the first direction. While the folded portions 342, 344, and 346 can have any curved shape, but preferably are in an arc shape to achieve smooth connecting to reduce optical loss.

As shown in FIG. 24, a heater electrode 382 of the bias control section B22 is disposed in the vicinity of the straight portion 343 that constitutes the curved waveguide C22. Furthermore, a control electrode 385 of the modulation section M is disposed in the vicinity of the straight portion 347.

Similarly, a curved waveguide C23 is formed midway through the branch waveguide 360. the curved waveguide C23 in this embodiment has the same shape as the curved waveguide C21. The curved waveguide C23 includes, in order from the branching section 351 side (light input side), a straight portion 361 extending in the first direction, a folded portion 362 formed in an arc shape, a straight portion 363 extending in the first direction, a folded portion 364 formed in an arc shape, and a straight portion 365 also extending in the first direction. A folded portion 366 formed in an arc shape and a straight portion 367 extending in the first direction are connected to the rear side of the straight portion 365. Here, the folded portions 362, 364, and 366 can have any curved shape, but preferably are in an arc shape to achieve smooth connecting to reduce optical loss.

As shown in FIG. 24, a heater electrode 383 of the bias control section B23 is disposed in the vicinity of the straight portion 363 that constitutes the curved waveguide C23. Furthermore, a control electrode 386 of the modulation section M is disposed in the vicinity of the straight portion 367.

Similarly, a curved waveguide C24 is formed midway through the branch waveguide 370. The curved waveguide C24 in this embodiment, has the same shape as the curved waveguide C21. The curved waveguide C24 has, in order from the branching section 351 side (light input side), a straight portion 371 extending in the first direction, a folded portion 372 formed in an arc shape, a straight portion 373 extending in the first direction, a folded portion 374 formed in an arc shape, and a straight portion 375 extending in the first direction. a folded portion 376 formed in an arc shape and a straight portion 377 extending in the first direction are connected to the rear side of the straight portion 375. While the folded portions 372, 374, and 376 can have any curved shape, but preferably are in an arc shape to achieve smooth connecting to reduce optical loss.

As shown in FIG. 24, a heater electrode 384 of bias control section B24 is disposed in the vicinity of the straight portion 373 of the curved waveguide C24. A control electrode 386 of the modulation section M is disposed in the vicinity of the straight portion 377.

The branch waveguide 330 and the branch waveguide 340 are combined at the combining section 391. The optical output side of the combining section 391 is connected to the branch waveguide 392. The branch waveguide 360 and the branch waveguide 370 are combined at the combining section 393. The optical output side of the combining section 393 is connected to the branch waveguide 394.

The branch waveguide 392 and the branch waveguide 394 are combined at the combining section 395. The combining section 395 is connected to the output optical waveguide 396 and the optical output end 397.

As shown in FIG. 24, even in the optical waveguide element 10D formed with multiple Mach-Zehnder optical waveguides, curved waveguides C21, C22, C23, and C24 can be arranged in the X direction. This prevents other branch waveguides from being included in the heat conduction range of the heater electrodes 381, 382, 383, and 384, thereby enabling the optical waveguide device 10D to be miniaturized and high density while suppressing thermal crosstalk.

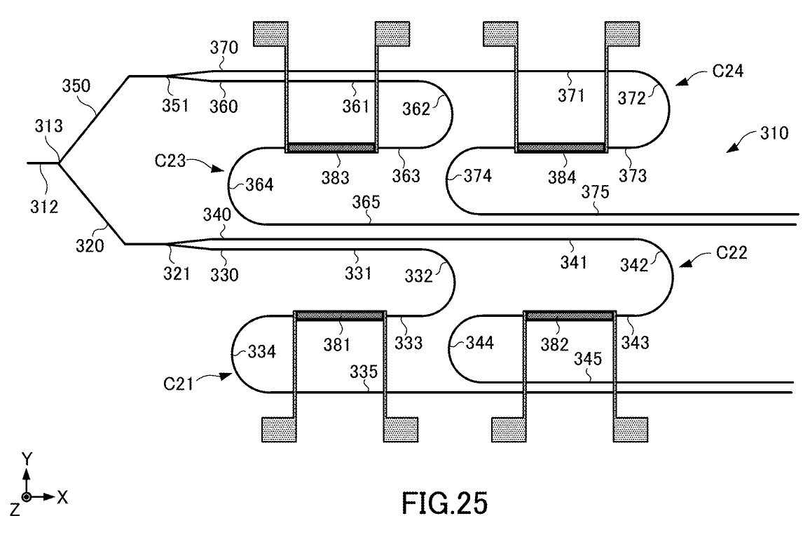

FIG. 25 is a partial plan view showing a first different example of a portion of a Mach-Zehnder optical waveguide according to the fourth embodiment of the present invention. Here, the combining section located at the end of the Mach-Zehnder optical waveguide is not shown. In the Mach-Zehnder optical waveguide shown in FIG. 24, the bias control sections B21, B22, B23, and B24 are arranged in a single row in the X direction. However, as shown in FIG. 25, the bias control sections B21, B22, B23, and B24 may also be arranged in two rows in the X direction.

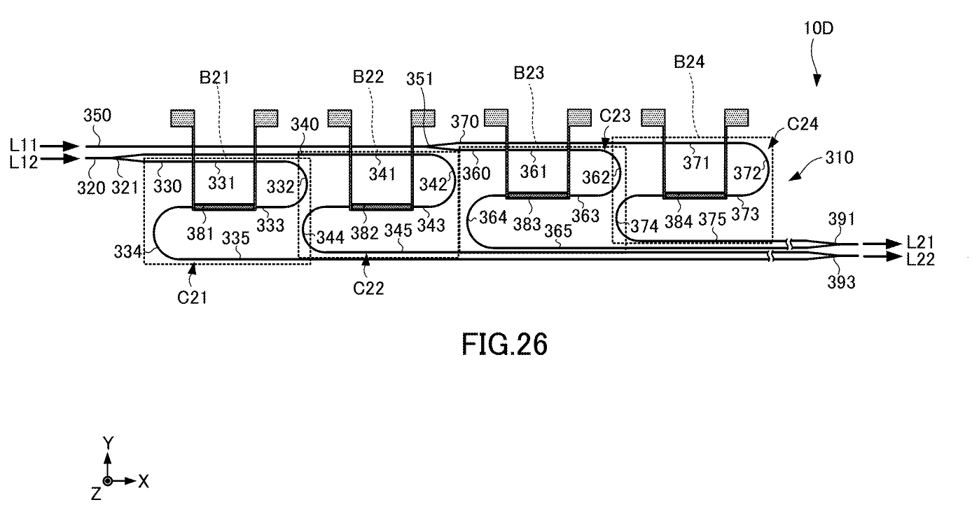

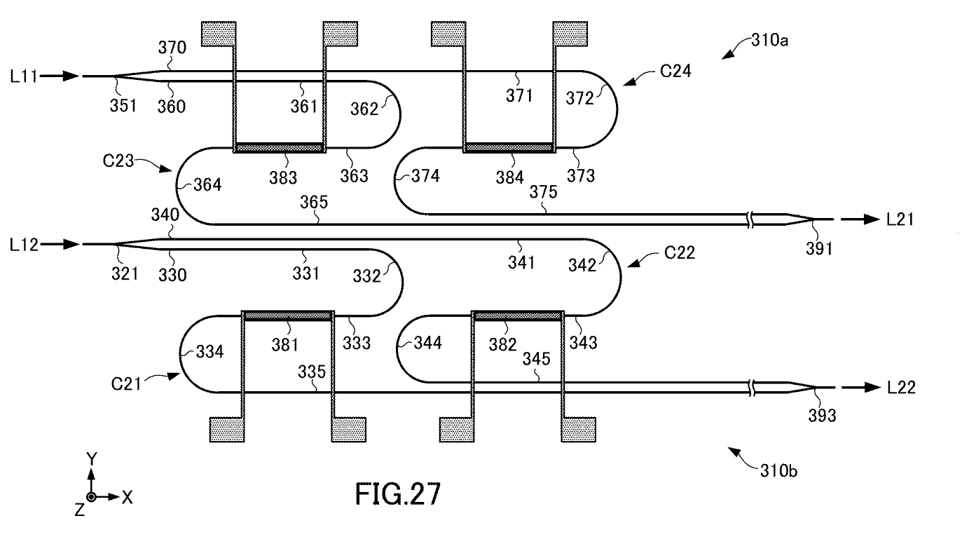

FIGS. 26 and 27 are partial plan views showing second and third different examples of a Mach-Zehnder optical waveguide according to the fourth embodiment of the present invention. The Mach-Zehnder optical waveguides shown in FIGS. 24 and 25 are Mach-Zehnder optical waveguides having a nested structure used in the optical modulators that perform QPSK modulation (QPSK optical modulators) and the optical modulators that perform DP-QPSK modulation (DP-QPSK optical modulators). However, the bias control sections B21, B22, B23, and B24 may be arranged in the X direction in parallel, independent Mach-Zehnder optical waveguides.

The configuration shown in FIGS. 26 and 27 differs from the configuration shown in FIGS. 24 and 25 in that two Mach-Zehnder optical waveguides are formed independently. Specifically, the optical waveguides 310 shown in FIGS. 24 and 25 are connected by a branching section 313 and a multiplexing unit 395 to form a nested Mach-Zehnder optical waveguide.

In the configuration shown in FIGS. 24 and 25, the optical waveguide 310 emits output light L2 when incident light L1 is incident thereon. In contrast, in the configuration shown in FIGS. 26 and 27, an optical waveguide 310a emits output light L21 when incident light L11 is incident thereon, and an optical waveguide 310b emits output light L22 when incident light L12 is incident thereon. The optical waveguides 310a and 310b are not connected to each other and form independent optical paths. In this way, the present invention can be applied even when the multiple independent Mach-Zehnder optical waveguides are formed in the optical waveguide device 10D.

The following description will be made about an optical modulator and an optical transmitter according to the present invention.

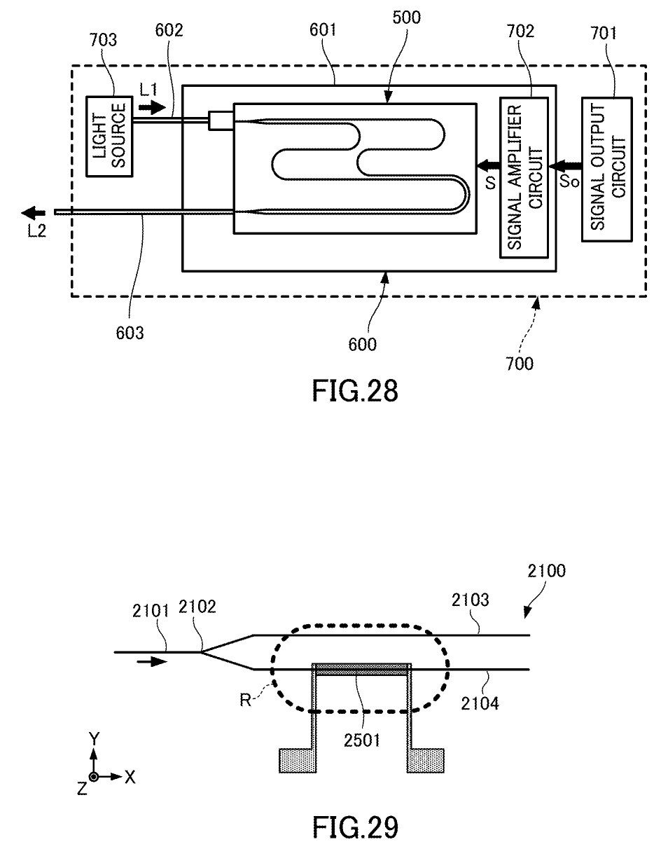

FIG. 28 is a plan view showing an optical modulator 600 and an optical transmitter 700 according to the present invention. The optical modulator 600 shown in FIG. 28 comprises an optical waveguide element 500, a housing 601, an input optical fiber 602, and an output optical fiber 603. As an example, the optical waveguide element 500 according to the present invention will now be described as being applied to a broadband coherent driver modulator (HB-CDM).

In the optical modulator 600, an optical waveguide element 500 is accommodated in the housing 601. The optical waveguide element 500 can be used any of the optical waveguide elements 10A, 10B, 10C, and 10D described in the above-described embodiments. An input optical fiber 602 is connected to the input section of the optical waveguide element 500, and an output optical fiber 603 is connected to the optical output section. In this way, by connecting the optical waveguide element 500 inside the housing 601 to the outside of the housing 601 through optical fiber, a compact optical modulator 600 can be provided. Furthermore, a spatial optical system may be interposed between the optical input section and the input optical fiber 602, and between the optical output section and the output optical fiber 603.

As shown in FIG. 28, an optical transmitter 700 can be configured by connecting a signal output circuit 701 that generates an electrical signal So (modulation signal), which is a high-frequency signal for modulation, and a signal amplifier circuit 702 that amplifies the electrical signal So to generate an amplified signal S (modulation signal), to the optical modulator 600. The signal output circuit 701 and the signal amplifier circuit 702 may be arranged outside the housing 601 of the optical modulator 600, but arranging them inside the housing 601 allows for efficient transmission of the modulated signal and a more compact optical transmitter 700.

Furthermore, the optical transmitter 700 may be equipped with a light source 703, and the light emitted by the light source 703 (incident light L1) may be input to the optical waveguide element 500. This makes it possible for the light output from the light source 703 to be modulated by the optical modulator 600, and for the modulated light (outgoing light L2) to be output from the optical transmitter 700. Furthermore, the optical modulator 600 may not be accommodated in the housing 601, but may be combined with another transmitting/receiving element to form a subassembly.

The above-described embodiments have been described to facilitate understanding of the present invention and are not intended to limit the present invention. The constitution elements disclosed in the above-described embodiments are intended to include all design modifications and equivalents that fall within the technical scope of the present invention. Furthermore, technical ideas obtained by appropriately combining the concepts illustrated in the respective embodiments are also encompassed by the present invention.

### Explanation of Symbols

10A, 10B, 10C, 10D, 500 optical waveguide element

21, 22, 23, 24 end face

101 substrate

101a convex portion

101b cut portion

102 reinforcing substrate

103 bonding layer

104 buffer layer

110, 310, 310a, 310b optical waveguide

111, 311 optical input end

112, 312, 1101, 1201, 2101, 2201 input optical waveguide

120, 313, 321, 351, 1102, 2102 branching section

130, 150, 320, 330, 340, 350, 360, 370, 392, 394, 1103, 1104, 1203, 1204, 1251, 1252, 1261, 1262, 2103, 2104, 2203, 2204, 2251, 2252, 2261, 2262 branch waveguide

131, 133 , 135, 137, 151, 153, 155, 157, 331, 333 , 335, 337, 341, 343, 345, 347, 361, 363, 365, 367 , 371, 373, 375, 377 straight portion

132, 134, 136, 152, 154, 156, 332, 334, 336, 342 , 344, 346, 362, 364, 366, 372, 374, 376 folded portion

160, 391, 393, 395 combining section

161, 396 output optical waveguide

162, 397 optical output end

171, 171a, 171b, 181, 381, 382, 383, 384, 1501, 1502, 1511, 1512, 2501, 2511, 2512 heater electrode

172, 182, 385, 386 wiring electrode

173, 183 electrode pad

174, 184 DC power supply

191, 385, 386 control electrode

192 high-frequency signal source

193 termination resistor

194 capacitor

210, 220 groove

215, 225 heat dissipation material

600 optical modulator

601 housing

602 input optical fiber

603 output optical fiber

700 optical transmitter

701 signal output circuit

702 signal amplifier circuit

703 light source

1100, 2100 Mach-Zehnder optical waveguide

1200, 2200 nested Mach-Zehnder optical waveguide

1202, 2202 first branching section

1250, 2250 second branching section

1260, 2260 third branching section

B11, B12, B21, B22, B23, B24 bias control section

C1, C2, C3, C4, C5, C6, C11, C12, C21, C22, C23, C24 curved waveguide

L1, L11, L12 incident light

L2, L21, L22 output light

M modulation section

R, R1, R2 thermal conduction range

S1, S2 starting point

T1, T2 end point

What is claimed is:

1. An optical waveguide element comprising:
a rectangular substrate made of electro-optical crystal and having a first direction and a second direction in a planar view;
an optical waveguide formed on the substrate;
a bias control section having a heater electrode for heating the optical waveguide;
wherein
the optical waveguide includes a Mach-Zehnder optical waveguide having a plurality of branch waveguides branched by at least one branching section;
the plurality of branch waveguides have curved waveguides, respectively, and the curved waveguides of each branch waveguide are arranged to be spaced apart along the first direction at a predetermined distance or more; and
the heater electrode is disposed on at least one of the curved waveguides.

2. The optical waveguide element according to claim 1, wherein the curved waveguides of each branch waveguide have the same shape.

3. The optical waveguide element according to claim 1, wherein the curved waveguide is configured to include N (N is a positive even number) curved folded portions and N+1 straight portions extending in the first direction which are alternately connected to each other.

4. The optical waveguide element according to claim 3, wherein the heater electrode is disposed in the vicinity of the straight portion.

5. The optical waveguide element according to claim 1, wherein the substrate is covered with a buffer layer, and the heater electrode is disposed so as to heat the curved waveguide through the buffer layer.

6. The optical waveguide element according to claim 1, wherein the curved waveguide has a second direction extending portion that increases the separation distance from other branch waveguides in the second direction.

7. The optical waveguide element according to claim 1, wherein a groove is formed by removing a portion of the substrate between the heater electrode for heating a specific optical waveguide and other optical waveguides.

8. The optical waveguide element according to claim 7, wherein a heat dissipation material made of metal is disposed in part or all of the groove.

9. The optical waveguide element according to claim 1, wherein a plurality of Mach-Zehnder optical waveguides are formed on the substrate.

10. The optical waveguide element according to claim 9, wherein a plurality of Mach-Zehnder optical waveguides are arranged nested or in parallel.

11. An optical modulator comprising the optical waveguide element according to claim 1, a housing for accommodating the optical waveguide element, an input optical fiber connected to the optical input portion of the optical waveguide element, and an output optical fiber connected to the optical output portion of the optical waveguide element.

12. An optical transmitter comprising the optical modulator according to claim 11, a light source that inputs optical waves to the optical modulator, and a signal output circuit that outputs a modulated signal.

13. The optical waveguide element according to claim 2, wherein the curved waveguide is configured to include N (N is a positive even number) curved folded portions and N+1 straight portions extending in the first direction which are alternately connected to each other.

14. The optical waveguide element according to claim 13, wherein the heater electrode is disposed in the vicinity of the straight portion.

15. The optical waveguide element according to claim 2, wherein the substrate is covered with a buffer layer, and the heater electrode is disposed so as to heat the curved waveguide through the buffer layer.

16. The optical waveguide element according to claim 2, wherein the curved waveguide has a second direction extending portion that increases the distance from other branch waveguides in the second direction.

17. The optical waveguide element according to claim 2, wherein a groove is formed by removing a portion of the substrate between the heater electrode for heating a specific optical waveguide and other optical waveguides.

18. The optical waveguide element according to claim 17, wherein a heat dissipation material made of metal is disposed in part or all of the groove.

19. The optical waveguide element according to claim 2, wherein a plurality of Mach-Zehnder optical waveguides are formed on the substrate.

20. The optical waveguide element according to claim 19, wherein a plurality of Mach-Zehnder optical waveguides are arranged nested or in parallel.
